(19) United States
(12) Patent Application Publication
(10) Pub. No.: US 2025/0081298 A1
(43) Pub. Date: Mar. 6, 2025

(54) INDUCTION HEATING DEVICE INCLUDING BOARDS ON WHICH HEATING COILS AND VESSEL DETECTION COILS ARE PRINTED

(71) Applicant: Samsung Electronics Co., Ltd., Suwon-si (KR)

(72) Inventors: Younghoon WOO, Suwon-si (KR); Kyounghwan KIM, Suwon-si (KR); Kyunghoon JUNG, Suwon-si (KR); Jonghun HA, Suwon-si (KR)

(73) Assignee: Samsung Electronics Co., Ltd., Suwon-si (KR)

(21) Appl. No.: 18/882,319

(22) Filed: Sep. 11, 2024

Related U.S. Application Data
(63) Continuation of application No. PCT/KR2024/012986, filed on Aug. 30, 2024.

(30) Foreign Application Priority Data
Aug. 30, 2023 (KR) 10-2023-0114670
Mar. 7, 2024 (KR) 10-2024-0032833

(51) Int. Cl. H05B 6/12

(52) U.S. Cl. CPC H05B 6/1245

(57) ABSTRACT

An induction heating device including a vessel detection coil layer that is patterned with a plurality of vessel detection coils printed thereon to detect a cooking vessel placed on the induction heating device; a plurality of heating coil pattern layers that are patterned with heating coils printed thereon; and an insulating layer between the plurality of heating coil pattern layers and the vessel detection coil layer, to insulate the plurality of heating coil pattern layers from the vessel detection coil layer, wherein the vessel detection coil layer, the plurality of heating coil pattern layers, and the insulating layer are in a stacked, hot-pressed heating coil board in which a thickness of the insulating layer is 140 μm or less.

This application is a continuation application, claiming priority under § 365 (c), of International Application No. PCT/KR2024/012986, filed on Aug. 30, 2024, which is based on and claims the benefit of Korean patent application number 10-2023-0114670, filed on Aug. 30, 2023, and Korean patent application number 10-2024-0032883, filed on Mar. 7, 2024, the disclosures of which are incorporated by reference herein in their entireties.

### TECHNICAL FIELD

The disclosure relates to an induction heating device including a plurality of stacked boards on which heating coils and vessel detection coils are printed.

### BACKGROUND ART

Various types of heating devices for cooking are used to heat food at home or in restaurants. Gas ranges fueled by gas were widely used, but recently, heating devices for cooking that use electricity instead of gas to heat an object to be heated, for example, a cooking vessel such as a pot, have been widely distributed.

Methods of heating an object to be heated by using electricity are broadly classified into resistance heating and induction heating. Resistance heating is a method of heating an object to be heated (e.g., a cooking vessel) by transmitting heat generated when current flows through a metal resistance wire or a non-metal heating element such as silicon carbide, through radiation or conduction. Induction heating is a method of generating an eddy current in an object to be heated including a metal component by using a magnetic field generated around a coil when high-frequency power of a certain magnitude is applied to the coil, such that the object is heated. Among such heating devices, induction ranges that apply induction heating generally have, in corresponding areas thereof, working coils (heating coils) respectively corresponding to a plurality of objects to be heated (cooking vessels) to heat the objects individually.

Induction ranges are heating devices for cooking that use the principle of induction heating, and are commonly referred to as induction cook devices, induction heating devices, or induction cooking devices. Induction ranges do not consume oxygen and do not emit waste gas compared to gas ranges, and thus may reduce indoor air pollution and lessen an increase in indoor temperature. In addition, induction ranges use an indirect method of inducing heat to an object to be heated itself, and have the advantages of high energy efficiency and stability, and low risk of burns because heat is generated only from the object to be heated and the contact surface is not heated, and thus, the demand for induction ranges has been continuously increasing recently.

Recently, induction ranges that allow an object to be heated to be placed anywhere on a top plate (hereinafter, referred to as ‘Anyplace’) have been developed. Such induction ranges enable an object to be heated that is placed in an area where a plurality of heating coils are arranged, to be inductively heated regardless of the size and location of the object to be heated.

In general, induction ranges include a heating coil around which a copper wire is wound, and a vessel detection sensor capable of detecting a cooking vessel. However, a structure in which a heating coil is printed on a board is required to improve productivity. Because a heating coil in an induction range needs to be able to conduct a large current, when manufacturing a heating coil that is printed on a board, it is necessary to precisely design the thickness and width of a pattern, a stack thickness, etc., in printing of the heating coil. In addition, in a structure in which a heating coil is printed on a board, a vessel detection sensor may be replaced with a vessel detection coil such that the vessel detection coil may also be provided on the printed board.

### DISCLOSURE

### Technical Solution

Aspects of embodiments of the disclosure will be set forth in part in the description which follows and, in part, will be apparent from the description, or may be learned by practice of the presented embodiments.

According to an embodiment of the disclosure, an induction heating device includes a vessel detection coil layer that is patterned with a plurality of vessel detection coils printed thereon to detect a cooking vessel placed on the induction heating device; a plurality of heating coil pattern layers that are patterned with heating coils printed thereon; and an insulating layer between the plurality of heating coil pattern layers and the vessel detection coil layer, to insulate the plurality of heating coil pattern layers from the vessel detection coil layer, wherein the vessel detection coil layer, the plurality of heating coil pattern layers, and the insulating layer are in a stacked, hot-pressed heating coil board in which a thickness of the insulating layer is 140 μm or less.

According to an embodiment of the disclosure, the insulating layer may include a resin content of 60% to 80% of a total composition.

According to an embodiment of the disclosure, the insulating layer may include a reinforced fiber. The plurality of heating coil pattern layers may include conductors with heights of 60 μm or greater. The reinforced fiber of the insulating layer may not contact a conductor of an uppermost heating coil pattern layer of the plurality of heating coil pattern layers or a conductor of the vessel detection coil layer.

According to an embodiment of the disclosure, the stacked, hot-pressed heating coil board may include a hole through which a temperature sensor configured to detect a temperature of a cooking vessel is passable.

According to an embodiment of the disclosure, the insulating layer may include at least two prepreg insulating layers.

According to an embodiment of the disclosure, the induction heating device may further include a connector terminal on the vessel detection coil layer. A first end of each vessel detection coil of the plurality of vessel detection coils may be connected to a lowermost layer of the stacked, hot-pressed heating coil board through a via hole. A second end of each vessel detection coil of the plurality of vessel detection coils may be connected to the connector terminal on the vessel detection coil layer.

According to an embodiment of the disclosure, the induction heating device may further include a top plate on which to place a cooking vessel, and at least one processor configured to control the induction heating device to detect, through the plurality of vessel detection coils, at least one of a material of a cooking vessel placed on the top plate, a position of the cooking vessel on the top plate, or a presence or absence of the cooking vessel.

According to an embodiment of the disclosure, the at least one processor may be configured to detect the material of the cooking vessel through a change in inductance due to the cooking vessel detected by the plurality of vessel detection coils.

According to an embodiment of the disclosure, the induction heating device may further include a display. The at least one processor may control the display to display a grade of the cooking vessel according to the detected material of the cooking vessel.

According to an embodiment of the disclosure, the plurality of heating coil pattern layers may include eight or more heating coil pattern layers.

According to an embodiment of the disclosure, a thickness of the stacked, hot-pressed heating coil board may be 3.3 mm or less.

According to an embodiment of the disclosure, the vessel detection coil layer may include a temperature sensor configured to measure a temperature of the stacked, hot-pressed heating coil board.

According to an embodiment of the disclosure, the induction heating device may further include at least one processor configured to, based on the measured temperature of the stacked, hot-pressed heating coil board being greater than a preset overheating reference temperature, reduce heating output through the stacked, hot-pressed heating coil board.

According to an embodiment of the disclosure, the temperature sensor may include a positive temperature coefficient (PTC) thermistor or a negative temperature coefficient (NTC) thermistor.

According to an embodiment of the disclosure, the induction heating device may further include an inverter board connected to the stacked, hot-pressed heating coil board through a connector. The stacked, hot-pressed heating coil board may include, in a lowermost layer, a signal layer connected to the inverter board through the connector.

According to an embodiment of the disclosure, a first end of each vessel detection coil of the plurality of vessel detection coils may be connected to the signal layer through a via hole, to be connected to a heating board connector that is vertically connected to the signal layer. A second end of each vessel detection coil of the plurality of vessel detection coils may be connected to a terminal of a heating board connector on the vessel detection coil layer.

According to an embodiment of the disclosure, the inverter board may include at least one inverter board connector that is connected to the heating board connector and mounted vertically on the inverter board.

According to an embodiment of the disclosure, the induction heating device may further include an intermediate board between the stacked, hot-pressed heating coil board and the inverter board, and at least one processor configured to control the induction heating device. The intermediate board may include a hole through which the heating board connector passes.

According to an embodiment of the disclosure, at least two prepreg insulating layers may be arranged between each sequential heating coil pattern layer among the plurality of heating coil pattern layers to insulate and bond the plurality of heating coil pattern layers.

According to an embodiment of the disclosure, provided is a method of producing a heating coil board for an induction heating device including a vessel detection coil layer, the method including forming a multilayer board including a vessel detection coil layer that is patterned with a vessel detection coil printed thereon, a plurality of heating coil pattern layers that are pattered with heating coils printed thereon, and an insulating layer between the plurality of heating coil pattern layers and the vessel detection coil layer to insulate and bond between the plurality of heating coil pattern layers and the vessel detection coil layer; and forming a heating coil board by hot-pressing the multilayer board, wherein a thickness of the insulating layer after the hot-pressing of the multilayer board is 140 μm or less.

### DESCRIPTION OF DRAWINGS

The above and other aspects, features, and advantages of certain embodiments of the disclosure will be more apparent from the following description, taken in conjunction with the accompanying drawings.

FIG. 1A is a diagram for describing an induction heating device according to an embodiment of the disclosure.

FIG. 1B is a diagram for describing an induction heating device according to an embodiment of the disclosure.

FIG. 2 is a cross-sectional view illustrating a state in which a cooking vessel is placed on an induction heating device, according to an embodiment of the disclosure.

FIG. 3 is an inverter circuit diagram of an induction heating device for operating a plurality of heating coils, according to an embodiment of the disclosure.

FIG. 4A illustrates an induction heating device using a quadrangular heating coil, according to an embodiment of the disclosure.

FIG. 4B illustrates an induction heating device using a quadrangular heating coil, according to an embodiment of the disclosure.

FIG. 5 is a diagram illustrating an induction heating device together with heating coils, according to an embodiment of the disclosure.

FIG. 6 is a diagram illustrating an Anyplace induction heating device in which heating coils are wound.

FIG. 7A is a diagram illustrating the appearance of wound heating coils.

FIG. 7B is a diagram of an example of an induction heating device equipped with a vessel detection sensor.

FIG. 8 illustrates a heating coil board of an induction heating device according to an embodiment of the disclosure.

FIG. 9A is a plan view of a heating coil board according to an embodiment of the disclosure.

FIG. 9B is a cross-sectional view illustrating interlayer connections of a heating coil board, according to an embodiment of the disclosure.

FIG. 9C is a cross-sectional view illustrating a 16-layer heating coil board and series-parallel connections between layers of the heating coil boards, according to an embodiment of the disclosure.

FIG. 9D is a cross-sectional view illustrating interlayer connections in a heating coil board including a vessel detection coil layer, according to an embodiment of the disclosure.

FIG. 10A illustrates a pattern layer including a vessel detection coil, according to an embodiment of the disclosure.

FIG. 10B is a diagram illustrating a vessel detection coil layer, according to an embodiment of the disclosure.

FIG. 10C is a diagram illustrating a heating coil pattern layer, according to an embodiment of the disclosure.

FIG. 11 illustrates a process of producing a heating coil board of an induction heating device, according to an embodiment of the disclosure.

FIG. 12 is a diagram illustrating a heating coil board layer by layer, according to an embodiment of the disclosure.

FIG. 13 is a diagram showing specifications for heating coil pattern widths, according to an embodiment of the disclosure.

FIG. 14 is a diagram showing a partial cross-section of a multilayer board according to an embodiment of the disclosure.

FIG. 15 show a characteristic curve of a temperature sensor according to an embodiment of the disclosure.

FIG. 16 show a characteristic curve of a temperature sensor according to an embodiment of the disclosure.

FIG. 17 illustrates a temperature sensing circuit according to an embodiment of the disclosure.

FIG. 18 illustrates a temperature sensing circuit according to an embodiment of the disclosure.

FIG. 19 illustrates a structure in which boards of an induction heating device are connected to each other, according to an embodiment of the disclosure.

FIG. 20 is a diagram illustrating a structure in which connectors are connected to a heating coil board in an induction heating device, according to an embodiment of the disclosure.

FIG. 21 is a diagram illustrating a structure in which a connector is mounted on a rear surface of a heating coil board in an induction heating device, according to an embodiment of the disclosure.

FIG. 22 is a block diagram of an induction heating device according to an embodiment of the disclosure.

FIG. 23 is a flowchart of producing a heating coil board, according to an embodiment of the disclosure.

FIG. 24 illustrates a vessel detection coil detecting a material of a cooking vessel, according to an embodiment of the disclosure.

### MODE FOR INVENTION

Terms used herein will be briefly described, and then an embodiment of the disclosure will be described in detail.

Although the terms used herein are selected from among common terms that are currently widely used in consideration of their functions in an embodiment of the disclosure, the terms may be different according to an intention of one of ordinary skill in the art, a precedent, or the advent of new technology. Also, in particular cases, the terms are discretionally selected by the applicant of the disclosure, in which case, the meaning of those terms will be described in detail in the corresponding description of an embodiment of the disclosure. Therefore, the terms used herein are not merely designations of the terms, but the terms are defined based on the meaning of the terms and content throughout the disclosure.

As used herein, the expression “at least one of a, b, or c” may indicate only a, only b, only c, both a and b, both a and c, both b and c, all of a, b, and c, or variations thereof.

Throughout the disclosure, when a part “includes” an element, it is to be understood that the part may additionally include other elements rather than excluding other elements as long as there is no particular opposing recitation. In addition, as used herein, the terms such as “ . . . er (or)”, “ . . . unit”, “ . . . module”, etc., denote a unit that performs at least one function or operation, which may be implemented as hardware or software or a combination thereof.

Hereinafter, an embodiment of the disclosure will be described in detail with reference to the accompanying drawings to allow those of skill in the art to easily carry out the embodiment. An embodiment of the disclosure may, however, be embodied in many different forms and should not be construed as being limited to the embodiment set forth herein. Also, parts in the drawings unrelated to the detailed description are omitted to ensure clarity of an embodiment of the disclosure, and like reference numerals in the drawings denote like elements.

Induction heating devices heat a cooking vessel by inducing a magnetic field in a heating coil to cause eddy currents to flow in the cooking vessel. Here, by making the heating coil and a vessel detection coil that detects a cooking vessel into a printed circuit board (PCB), assembly becomes easier and the durability of the induction heating device increases. However, in a case in which the heating coil and the vessel detection coil is printed on a board, a large alternating current flows through the heating coil, causing the low-power vessel detection coil to be interfered with, and thus, it is necessary to design the vessel detection coil to minimize interference from the heating coil. In addition, in a case in which heating coils are applied for patterning to form a plurality of pattern layers, it is necessary to design appropriate insulation.

Thus, according to an embodiment of the disclosure, an induction heating device is disclosed including a pattern layer including a vessel detection coil, and a plurality of heating coil pattern layers. In the disclosure, a board may be a PCB having printed thereon a patterned circuit. When a plurality of heating coil pattern layers are stacked, an insulating layer may be arranged between them.

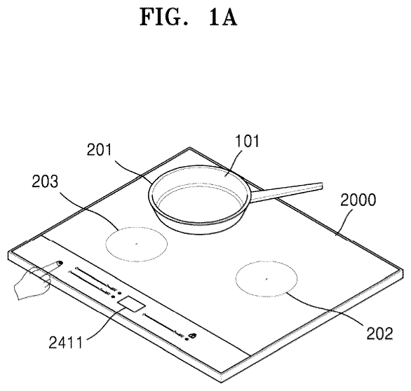

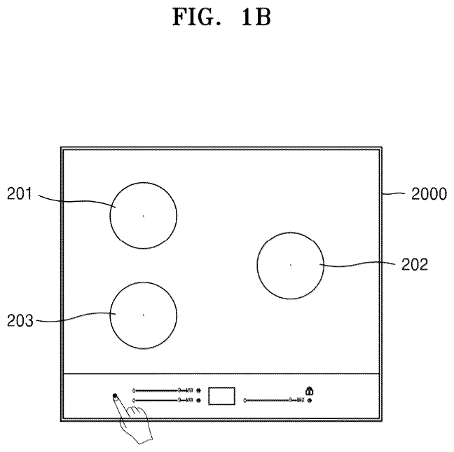

FIG. 1A is a diagram for describing an induction heating device according to an embodiment of the disclosure.

Referring to FIG. 1A, an induction heating device 2000 according to an embodiment of the disclosure may include a plurality of heating zones 201, 202, and 203. Hereinafter, the induction heating device 2000 may be referred to as an induction heating device, an induction cooking device, or simply a heating device. All of the components illustrated in FIG. 1A are not essential components. The induction heating device 2000 may be implemented with more or fewer components than the illustrated components.

A cooking vessel 101 may be a device for heating contents inside the cooking vessel 101. The contents of the cooking vessel 101 may be liquids, such as water, tea, coffee, soup, juice, wine, oil, etc., or solids, such as butter, meat, vegetables, bread, rice, etc., but are not limited thereto.

According to an embodiment of the disclosure, the cooking vessel 101 may be wirelessly receive power from the induction heating device 2000 by using electromagnetic induction. Thus, the cooking vessel 101 according to an embodiment of the disclosure may not include a power cord to be connected to a power outlet.

According to an embodiment of the disclosure, the type of cooking vessel 101 that wirelessly receives power from the induction heating device 2000 may vary. The cooking vessel 101 may be a general induction heating (IH) vessel (hereinafter, referred to as ‘IH vessel’) including a magnetic material. A magnetic field may be induced in the cooking vessel 101 (IH metal) itself.

The cooking vessel 101 may be a general IH vessel such as a pot, a frying pan, or a steamer. The cooking vessel 101 may include a cooker appliance. The cooker appliance may be a device into which a typical IH vessel may be inserted or removed. According to an embodiment of the disclosure, the cooker appliance may be an appliance capable of automatically cooking contents according to a recipe. Depending on the intended use, the cooker appliance may be referred to as a pot, a rice cooker, or a steamer. For example, the cooker appliance having inserted therein an inner pot for cooking rice may be referred to as a rice cooker. Hereinafter, the cooker appliance may be defined as a smart pot.

According to an embodiment of the disclosure, in a case in which the cooking vessel 101 includes a communication interface, the cooking vessel 101 may communicate with the induction heating device 2000. The communication interface may include a short-range wireless communication interface, a long-range communication interface, and the like. The short-range wireless communication interface may include, but is not limited to, a Bluetooth communication unit, a Bluetooth Low Energy (BLE) communication unit, a near-field communication (NFC) unit, a wireless local area network (WLAN) (e.g., Wi-Fi) communication unit, a Zigbee communication unit, an Infrared Data Association (IrDA) communication unit, a Wi-Fi Direct (WFD) communication unit, an ultra-wideband (UWB) communication unit, an Ant+ communication unit, and the like. In a case in which the cooking vessel 101 is remotely controlled by a server (not shown) in an internet-of-Things (IoT) environment, the long-range communication interface may be used to communicate with the server. The long-range communication interface may include the Internet, a computer network (e.g., a local area network (LAN) or a wide area network (WAN)), and a mobile communication unit. The mobile communication unit may include, but is not limited to, a 3^{rd} Generation (3G) module, a 4^{th} Generation (4G) module, a 5^{th} Generation (5G) module, a Long-Term Evolution (LTE) module, a narrowband IoT (NB-IoT) module, an LTE for Machines (LTE-M) module, and the like.

According to an embodiment of the disclosure, the cooking vessel 101 may transmit information to the server (not shown) through the induction heating device 2000. For example, the cooking vessel 101 may transmit information obtained from the cooking vessel 101 (e.g., temperature information of the contents) to the induction heating device 2000 through short-range wireless communication (e.g., Bluetooth or BLE). Here, the induction heating device 2000 may transmit information obtained from the cooking vessel 101 to a server by connecting to the server by using a WLAN (Wi-Fi) communication unit or a long-range communication unit (e.g., the Internet). In addition, the server may provide a user with the information obtained from the cooking vessel 101 received from the induction heating device 2000 through a mobile terminal (not shown) connected to the server. According to an embodiment of the disclosure, the induction heating device 2000 may directly transmit the information obtained from the cooking vessel 101 to the mobile terminal of the user through device-to-device (D2D) communication (e.g., WFD communication or BLE communication).

In addition, according to an embodiment of the disclosure, the cooking vessel 101 may directly transmit information of the cooking vessel 101 (e.g., temperature information of contents) to the server through a communication interface (e.g., a WLAN (Wi-Fi) communication unit). In addition, the cooking vessel 101 may directly transmit information obtained from the cooking vessel 101 (e.g., temperature information of contents) to the mobile terminal of the user through short-range wireless communication (e.g., Bluetooth or BLE) or D2D communication.

The induction heating device 2000 according to an embodiment of the disclosure may be a device that wirelessly transmits power to the cooking vessel 101 located on a top plate of the induction heating device 2000 by using electromagnetic induction. The induction heating device 2000 may include a working coil that generates a magnetic field for inductively heating the cooking vessel 101. The working coil is a coil for generating a magnetic field through the flow of electricity, and may be referred to as a heating coil throughout the disclosure.

Generating a magnetic field by a heating coil may include transmitting power by using a magnetic field induced in an IH metal (e.g., iron) by using a magnetic induction method. For example, the induction heating device 2000 may cause an eddy current to be generated in the cooking vessel 101 by flowing a current through the heating coil to form a magnetic field.

According to an embodiment of the disclosure, the induction heating device 2000 may include a plurality of heating coils. For example, in a case in which the top plate of the induction heating device 2000 includes a plurality of cooking zones, the induction heating device 2000 may include a plurality of heating coils corresponding to the plurality of cooking zones, respectively. In addition, the induction heating device 2000 may include a high-power cooking zone having a first heating coil provided on the inner side and a second heating coil provided on the outer side. The high-power cooking zone may include two or more heating coils.

The top plate of the induction heating device 2000 according to an embodiment of the disclosure may be made of reinforced glass such as ceramic glass so as not to be easily broken. In addition, the top plate of the induction heating device 2000 may include a guide mark for guiding through a cooking zone where the cooking vessel 101 needs to be located.

The induction heating device 2000 according to an embodiment of the disclosure may detect whether the cooking vessel 101 including a magnetic body is placed on the top plate. For example, the induction heating device 2000 may detect that the cooking vessel 101 is located on the top plate of the induction heating device 2000, based on a change in a current value (inductance) of a heating coil due to the approach of the cooking vessel 101. In addition, when the cooking vessel 101 is placed on the top plate, a vessel detection coil of the induction heating device 2000 may detect the cooking vessel 101. In an embodiment, the induction heating device 2000 may include at least one processor including processing circuitry and a memory storing instructions that, when executed by the at least one processor individually or collectively, cause the induction heating device to detect the cooking vessel 101 when the cooking vessel 101 is placed on the top plate with the vessel detection coil.

According to an embodiment of the disclosure, the induction heating device 2000 may include a communication interface for performing communication with an external device. For example, the induction heating device 2000 may perform communication with the cooking vessel 101 or a server through the communication interface. The communication interface may include a short-range communication unit (e.g., an NFC communication unit, a Bluetooth communication unit, or a BLE communication unit), a mobile communication unit, and the like.

According to an embodiment of the disclosure, the induction heating device 2000 may detect the cooking vessel 101 located on the top plate, through the communication interface. For example, the induction heating device 2000 may detect the cooking vessel 101 by receiving a packet transmitted from the cooking vessel 101 located on the top plate by using short-range wireless communication (e.g., BLE mesh network or Bluetooth).

According to an embodiment of the disclosure, even in a case in which the cooking vessel 101 does not include a communication interface, the induction heating device 2000 may detect whether the cooking vessel 101 is placed on the top plate of the induction heating device 2000, through the vessel detection coil.

According to an embodiment of the disclosure, the induction heating device 2000 may display information related to the cooking vessel 101 through a user interface. For example, when the cooking vessel 101 is detected, the induction heating device 2000 may display information such as identification information of the cooking vessel 101, location information of the cooking vessel 101, a presence or absence of the cooking vessel 101, or a material of the cooking vessel 101, on a display included in the user interface.

Referring to FIG. 1A, when the user places the cooking vessel 101 (e.g., a pot) on the top plate of the induction heating device 2000, the induction heating device 2000 may provide the user with identification information (e.g., ‘pot’) of the cooking vessel 101, location information (e.g., ‘located on the right heating zone’) of the cooking vessel 101, and material information of the cooking vessel 101, as an output interface on a display 2411. The material information of the cooking vessel 101 may be detected through a change in inductance when the cooking vessel 101 is placed on the top plate and heated, and the material information of the cooking vessel 101 may be information related to the degree to which the cooking vessel 101 is heated when the same heating power is applied. For example, there may be a case in which the cooking vessel 101 is made of material A, with which 1 liter of water is boiled to 100° C. in 1 minute with a heating power of 1.5 KW, and there may be a case in which the cooking vessel 101 is made of material B, with which 1 liter of water is boiled to 100° C. in 2 minutes with a heating power of 1.5 KW. The instructions stored in a memory executed by at least one processor of the induction heating device 2000 may cause the induction heating device 2000 to display such materials by grade (e.g., grade 1 to grade 7) on a display such that a consumer may easily determine whether the cooking vessel 101 that he or she currently owns is made of a material with good heating efficiency.

FIG. 1B is a diagram for describing an induction heating device according to an embodiment of the disclosure.

FIG. 1B is a perspective view of the induction heating device 2000 of FIG. 1A without a cooking vessel. The induction heating device 2000 of FIG. 1B may include a plurality of heating zones 201, 202, and 203, and thus may heat a plurality of cooking vessels simultaneously. When the induction heating device 2000 heats a plurality of cooking vessels simultaneously, heating coils respectively corresponding to the heating zones may operate. The induction heating device 2000 of FIGS. 1A and 1B is an induction heating device in which heating zones are preset to correspond to respective cooking vessels.

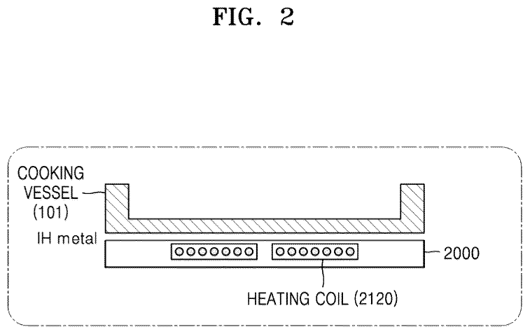

FIG. 2 is a cross-sectional view illustrating a state in which a cooking vessel is placed on an induction heating device, according to an embodiment of the disclosure.

Referring to FIG. 2, the cooking vessel 101 may include a magnetic material (e.g., IH metal) in which a magnetic field may be induced.

The cooking vessel 101 may be inductively heated by the induction heating device 2000, and may be any one of various types of vessels including a magnetic material. IH refers to a method of heating an IH metal by using electromagnetic induction. For example, when an alternating current is supplied to a heating coil 2120 of the induction heating device 2000, a time-varying magnetic field is induced inside the heating coil 2120. The magnetic field generated by the heating coil 2120 passes through the bottom surface of the cooking vessel 101. When the time-varying magnetic field passes through an IH metal (e.g., iron, steel nickel, or various types of alloys) included in the bottom surface of the cooking vessel 101, a current rotating around the magnetic field is generated in the IH metal. This rotating current is referred to as ‘eddy current’, and a phenomenon in which a current is induced by a time-varying magnetic field is referred to as ‘electromagnetic induction’. Heat is generated at the bottom surface of the cooking vessel 101 by eddy currents and the resistance of the IH metal (e.g., iron). At this time, the contents of the cooking vessel 101 may be heated by the generated heat.

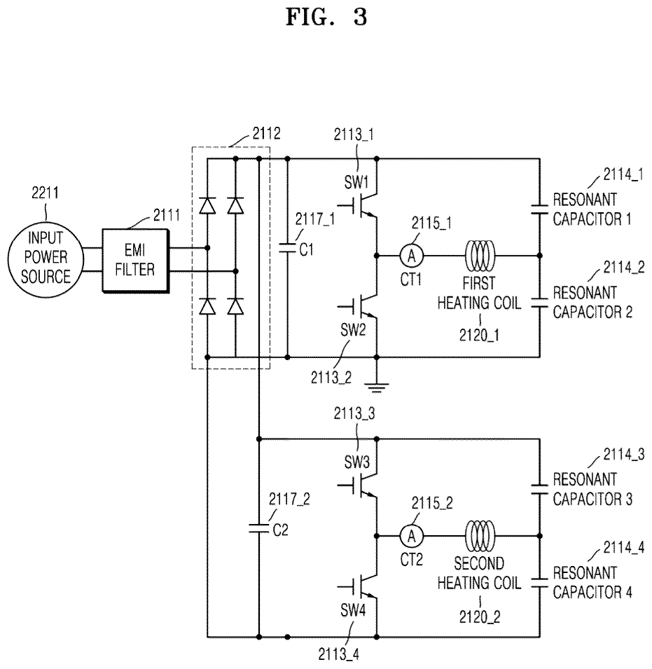

FIG. 3 is an inverter circuit diagram of an induction heating device for operating a plurality of heating coils, according to an embodiment of the disclosure.

Referring to FIG. 3, an input power source 2211 is an alternating-current power source. An alternating-current voltage of the input power source 2211 is rectified by a rectifier circuit 2112 through an electromagnetic interference (EMI) filter 2111. A diode may be used as the rectifier circuit 2112, as an element for converting alternating-current voltage into a direct-current voltage. A diode is used as an element of the rectifier circuit 2112, but a thyristor or other types of switching elements may also be used. When an alternating-current voltage is converted into a direct-current voltage through the rectifier circuit 2112, the direct-current voltage may be smoothed by DC link capacitors 2117_1 and 2117_2.

FIG. 3 illustrates two resonant circuits assuming a case in which there are two heating coils 2120_1 and 2120_2, but in a case in which there are three heating zones and thus three heating coils are necessary, additional resonant circuits may be added.

The direct-current voltage smoothed by the DC link capacitor 2117_1 generates a magnetic field in the first heating coil 2120_1 due to resonance between the first heating coil 2120_1, and a resonant capacitor 1 2114_1 and a resonant capacitor 2 2114_2 through a switching operation of two switch elements SW1 2113_1 and SW2 2113_2. The magnetic field generated in the first heating coil 2120_1 generates an eddy current in the cooking vessel placed on the first heating coil 2120_1, thereby heating the contents of the cooking vessel. CT1 2115_1 is a current sensor for detecting a current flowing through the first heating coil 2120_1.

Similarly, the direct-current voltage smoothed by the DC link capacitor 2117_2 on the lower side generates a magnetic field in the second heating coil 2120_2 due to resonance between the second heating coil 2120_2, and a resonant capacitor 3 2114_3 and a resonant capacitor 4 2114_4 through a switching operation of two switch elements SW3 2113_3 and SW4 2113_4. The magnetic field generated in the second heating coil 2120_2 generates an eddy current in the cooking vessel placed on the second heating coil 2120_2, thereby heating the contents of the cooking vessel. CT2 2115_2 is a current sensor for detecting a current flowing through the second heating coil 2120_2.

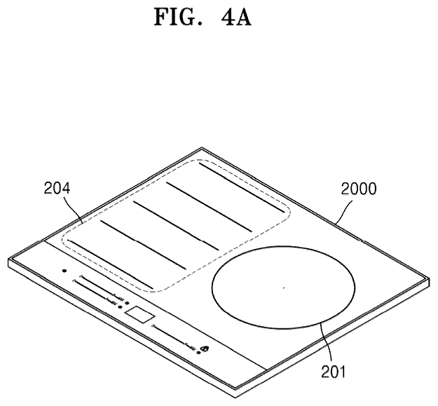

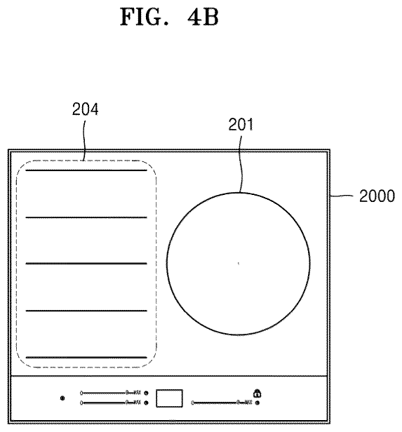

FIG. 4A and FIG. 4B illustrate an induction heating device using a quadrangular heating coil, according to an embodiment of the disclosure.

Referring to FIG. 4A and FIG. 4B, the induction heating device 2000 according to an embodiment of the disclosure may include a circular first heating zone 201 operated by a circular heating coil, and a quadrangular heating zone 204 formed by a quadrangular heating coil. The quadrangle may be a rectangle, and the quadrangular heating zone 204 may have a plurality of rectangular heating coils formed on the bottom surface thereof. Alternatively, a plurality of circular heating coils may be used for the bottom surface of the quadrangular heating zone 204.

The use of a quadrangular heating coil in the induction heating device 2000 has the advantage of eliminating non-cooking zones, for example, when placing a quadrangular pot thereon. In addition, no matter where the user of the induction heating device 2000 places a cooking vessel on the quadrangular heating zone 204, the induction heating device 2000 may recognize the cooking vessel and operate the quadrangular heating coil necessary for heating the cooking vessel, to heat the contents of the cooking vessel. Although FIG. 4A and FIG. 4B illustrate a case in which the circular first heating zone 201 and the quadrangular heating zone 204 are provided together, the induction heating device 2000 according to an embodiment of the disclosure may include only quadrangular heating zones. In this case, the induction heating device 2000 is referred to as an Anyplace induction heating device because it detects a cooking vessel no matter where it is placed, and operates the heating coil.

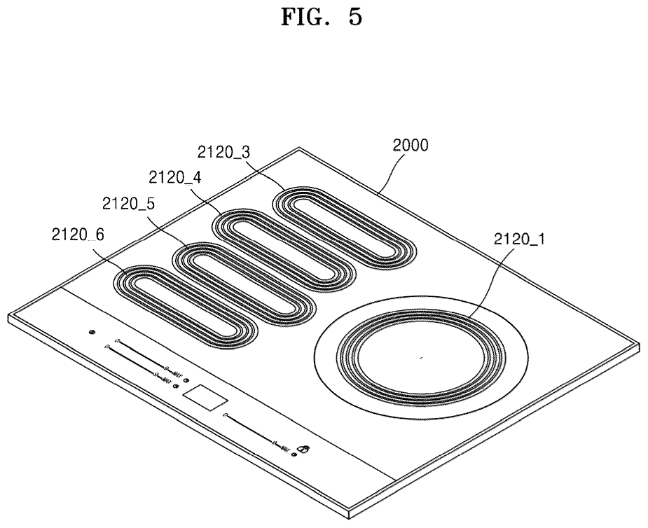

FIG. 5 is a diagram illustrating an induction heating device together with heating coils, according to an embodiment of the disclosure.

FIG. 5 illustrates the appearance of the induction heating device 2000, and heating coils wound therein. The wound heating coils are not actually visible from the outside. As illustrated in FIG. 5, in the induction heating device 2000 according to an embodiment of the disclosure, four quadrangular heating coils 2120_3, 2120_4, 2120_5, and 2120_6 corresponding to the quadrangular heating zone 204 are wound sequentially from an upper portion of the induction heating device 2000. This is only an embodiment of the disclosure, and the number of quadrangular heating coils 2120_3, 2120_4, 2120_5, and 2120_6 corresponding to the quadrangular heating zone 204 may be four or more, or may be less than four. In addition, in a case in which the induction heating device 2000 is the Anyplace induction heating device described above, the first heating coil 2120_1 may also be replaced by one or more quadrangular heating coils.

On the right side of the top plate of the induction heating device 2000 of FIG. 5, a circular first heating coil 2120_1 corresponding to a circular first heating zone 201 is wound, as illustrated in FIG. 1.

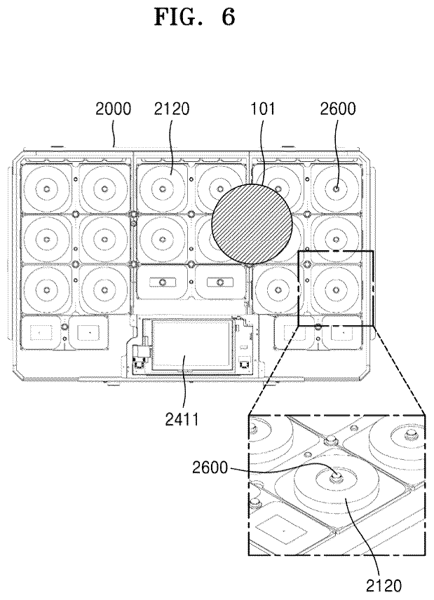

FIG. 6 is a diagram illustrating an Anyplace induction heating device in which heating coils are wound.

Referring to FIG. 6, the heating coils 2120 of the induction heating device 2000 are made of Litz wires wound into a circle and densely arranged under the top plate of the induction heating device 2000 such that there is no lack of heating regardless of where the cooking vessel 101 is placed. The induction heating device 2000 as illustrated in FIG. 6 may be referred to as an Anyplace induction heating device. In an Anyplace induction heating device as illustrated in FIG. 6, heating coils are arranged densely such that there are no blind spots between the heating coils. In addition, at least one vessel detection coil may also be arranged where the heating coils are arranged.

In an embodiment of the disclosure, a temperature sensor 2600 for sensing the temperature of the cooking vessel 101 may be arranged in the center of each heating coil 2120.

When heating coils are densely arranged on the induction heating device 2000 as illustrated in FIG. 6, vessel detection coils may also be densely arranged, and a plurality of vessel detection coils may detect whether the cooking vessel 101 is present and, if present, where the cooking vessel 101 is located on the top plate of the induction heating device 2000, based on changes in current on the vessel detection coils. For example, in FIG. 6, the value of a current flowing in the vessel detection coil below where the cooking vessel 101 is placed may be different from the values of currents flowing in the vessel detection coils in other positions where the cooking vessel 101 is not placed. Through the difference in current value, the induction heating device 2000 may first detect the presence of the cooking vessel 101, and identify the location of the cooking vessel 101. When the location of the cooking vessel 101 is determined, the induction heating device 2000 may use only the heating coil under the cooking vessel 101 for heating.

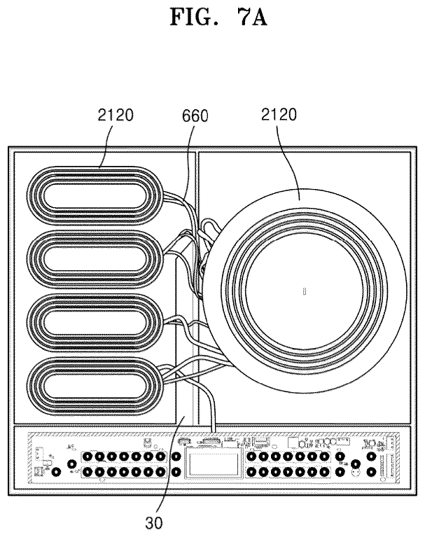

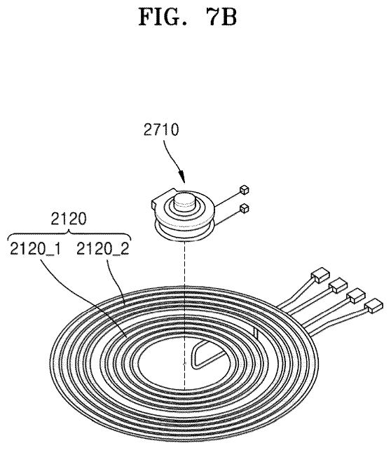

FIG. 7A is a diagram illustrating the appearance of wound heating coils.

FIG. 7A illustrates that the heating coil 2120 is connected to an inverter board 30 through a wire 660. The inverter board 30 may include an inverter connector to which the wire 660 may be connected. The heating coil 2120 may be manufactured by winding a Litz wire into a round shape, or for the quadrangular heating coils 2120_3, 2120_4, 2120_5, and 2120_6, into a quadrangular shape. A conductor wire may be used as the Litz wire. A copper wire is often used as the Litz wire. An end of each heating coil 2120 may be connected to the inverter board 30 through the wire 660. In a case in which all heating coils 2120 are manufactured by using Litz wires, there may be blind spots between a plurality of heating coils in the Anyplace induction heating device where the cooking vessel 101 may be freely placed anywhere on the top plate, and thus, it is necessary to manufacture the heating coils small and place them densely. In addition, in a case in which the heating coil 2120 is manufactured by using a Litz wire, because the Litz wire needs to be wound through manual or semi-automatic work, the work process takes a lot of time, and there is also a possibility that heating coil products may not be consistent. When the heating coil products are not consistent, the inductance determined by the heating coil may be inconstant. In addition, as illustrated in FIG. 7A, in a case in which a heating coil made of a Litz wire is used, it is necessary to use numerous wires 660 connected to the heating coils 2120 and the inverter board 30, which not only complicates the work process but also makes the assembly process inefficient, and increases the manufacturing cost. In addition, wire damage may occur as long wires get tangled with each other. This may cause poor quality of the wires and the induction heating device 2000.

Recently, induction heating devices and their components are gradually becoming smaller, slimmer, and thinner, and in line with this trend, the issue of reducing heat generation from circuit components is also emerging. Various cooling structures have been developed to resolve heat generation from circuit components, but as the number of heating coils increases, connections between circuit components become more complex, and spaces for arranging heating coils, wires connected to heating coils, and inverter boards become narrower, making it difficult to design circuit components and cooling structures.

Thus, in order to solve this issue, a plurality of heating coils of the induction heating device 2000 according to an embodiment of the disclosure may be manufactured by printing a plurality of heating coils on a heating coil board rather than by winding them as Litz wires. In addition, a heating coil board may be produced by hot-pressing a multilayer board on which a plurality of heating coil pattern layers having printed thereon heating coils are stacked. In addition, the multilayer board may include an insulating material for insulation, along with each heating coil pattern layer made of a printed heating coil.

In addition, the heating coil board produced in this manner may be connected to the inverter board 30 through the wire 660, but a method of connecting between boards by using a fixed vertical connector mounted on each board (board-to-board connection) may be used. According to an embodiment of the disclosure, the heating coil board may be connected to an inverter board or an intermediate board through a connector.

The heating coil 2120 printed in the heating coil board resonates with a resonant capacitor (not shown) on the inverter board 30 due to driving of an inverter, thereby heating the cooking vessel 101. The inverter board 30 may also be referred to as an inverter printed board assembly (PBA).

FIG. 7B is a diagram of an example of an induction heating device equipped with a vessel detection sensor.

The heating coil 2120 may include the first heating coil 2120_1 wound on the inside, and the second heating coil 2120_2 wound on the outside. A vessel detection sensor 2710 may be located in the center of the first heating coil 2120_1 to detect whether a cooking vessel is placed on the top plate of the induction heating device 2000. FIG. 7B illustrates an example in which the vessel detection sensor 2710 is mounted in a case in which a heating coil board 10 is not used in the induction heating device 2000, and a heating coil wound with a Litz wire is used. In a case in which the vessel detection sensor 2710 illustrated in FIG. 7B is used, manual work to wind the first heating coil 2120_1 and the second heating coil 2120_2, and assembly work to integrate the heating coil 2120 with the vessel detection sensor 2710 are required. Unlike FIG. 7B, in a case in which a heating coil board produced by patterning a board with heating coils printed thereon is used, the board may also be patterned with a printed vessel detection coil capable of detecting a vessel, thus, the assembly process may be reduced, the number of parts may be reduced, and accordingly, the manufacturing cost may be reduced. In addition, when the heating coil board is used, the number of parts is reduced and coil winding work is not required, and thus, quality issues that may occur due to wire winding may be prevented.

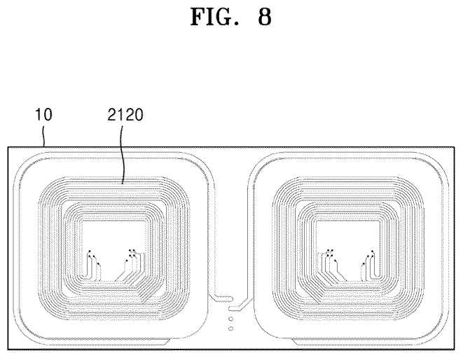

FIG. 8 illustrates a heating coil board of an induction heating device according to an embodiment of the disclosure.

FIG. 8 illustrate the heating coil board 10 patterned with the heating coil 2120.

The heating coil may be provided in the form of a conductor printed on the heating coil board 10. In an embodiment of the disclosure, the heating coil board 10 on which two or more heating coil pattern layers are stacked may be employed as the heating coil board 10. In order to implement a high-power (maximum over 3 KW) induction heating device by using the heating coil board 10 on which two or more heating coil pattern layers are stacked, the thickness of copper of a first layer (the thickness of a coil pattern) needs to be about 500 μm. This may increase the skin effect and thus increase coil loss. In order to implement high heating power while reducing the skin effect, a method of reducing the thickness and width of a heating coil pattern and securing the current capacity by connecting a plurality of heating coil patterns in parallel may be considered. In this case, the number of interlayer connections for connecting a plurality of heating coils in parallel may increases, and heating coil loss due to the wire lengths may also increase. Thus, according to an embodiment of the disclosure, a multilayer board on which multilayer heating coil pattern layers are stacked, which may reduce the number of interlayer connections while reducing heating coil loss, and the heating coil board 10 produced by hot-pressing the multilayer board may be employed. Here, ‘multilayer’ may include four or more layers. In an embodiment of the disclosure, a pattern layer with the heating coil 2120 may be provided on the heating coil board 10 in the shape of a sheet. For example, the heating coil 2120 may be in the form of a printed circuit board formed through a patterning process using photoresist or the like on the heating coil board 10. In an embodiment of the disclosure, the plurality of heating coils may have the same shape and size. The plurality of heating coils does not necessarily have the same shape and size. For example, at least one of the plurality of heating coils may differ in at least one of shape or size from the other heating coils.

The heating coil board 10 may replace the plurality of heating coils provided in the induction heating device 2000 illustrated in FIG. 6. In this manner, the Anyplace induction heating device 2000 with the heating coil board 10 may be produced.

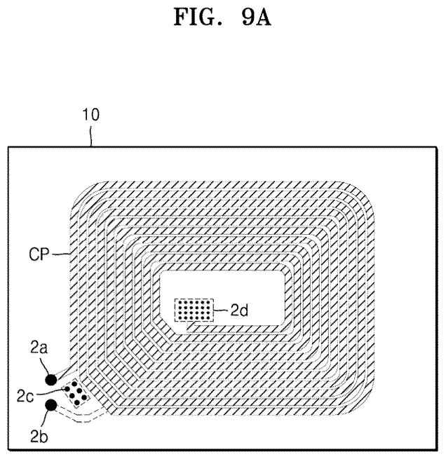

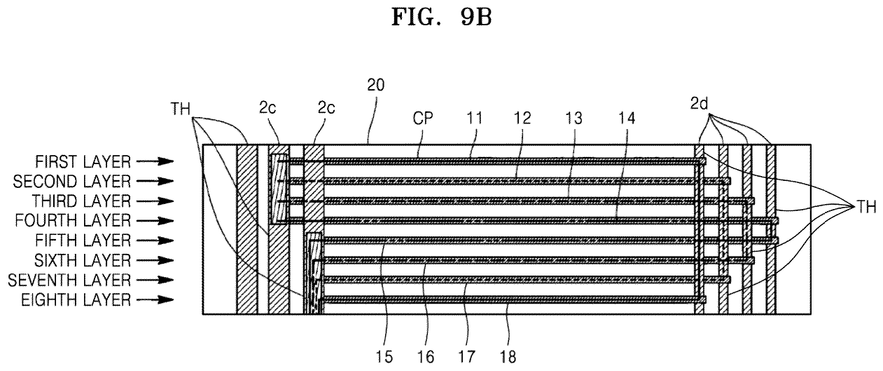

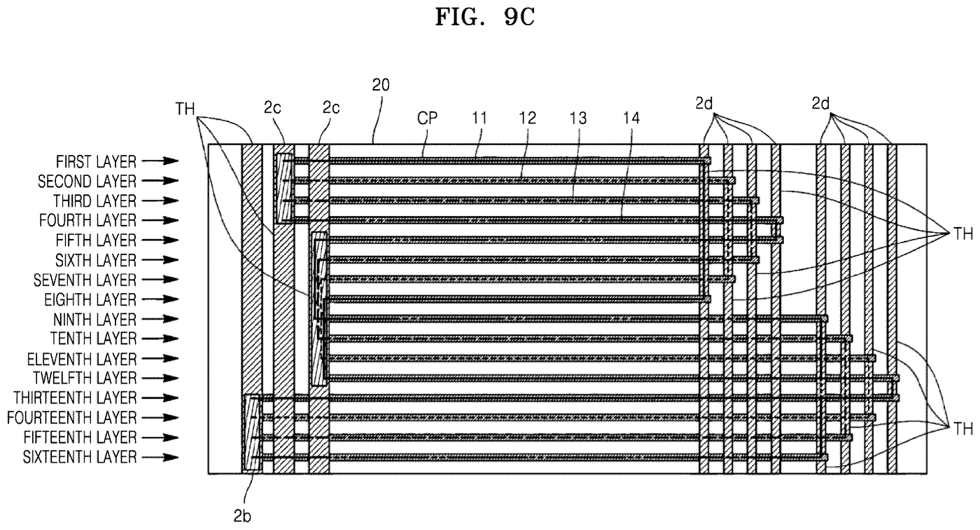

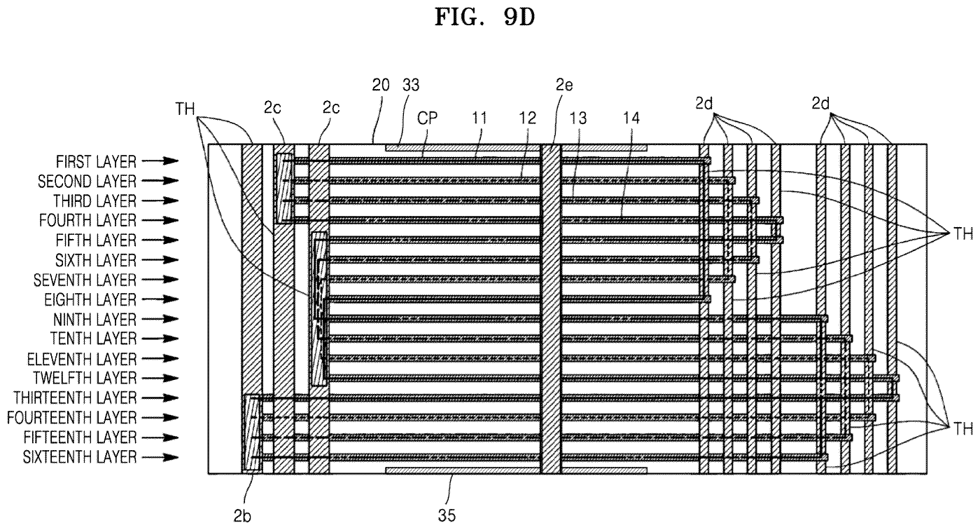

FIG. 9A is a plan view of a heating coil board according to an embodiment of the disclosure.

Referring to FIG. 9A, the heating coil board 10 may be a printed circuit board formed by stacking four or more heating coil pattern layers (PLs) on which a coil pattern CP is formed. An insulating layer may be inserted between the heating coil pattern layers. According to the induction heating device 2000 having the heating coil board 10, because the heating coil board 10 has a stack structure with four or more layers, the thickness of the heating coil in one layer, for example, the thickness of copper, may be significantly reduced, the width of a pattern may be reduced, and thus, the influence of the skin effect may be reduced to decrease coil loss. This is only an embodiment of the disclosure, and the heating coil board 10 may have a stack structure with five or more layers.

In the heating coil board 10, one or more coil patterns are formed in each pattern layer of a plurality of heating coil pattern layers. For example, the coil pattern CP may be spiral. For example, the coil pattern CP may be formed by a plurality of coil elements that are approximately rectangular in plan view, as illustrated in FIG. 8. For example, the coil pattern CP may be formed by a plurality of coil elements that are circular in plan view. The shape of the coil element forming the coil pattern CP is not limited to the shapes described above. The heating coil board 10 may have a plurality of serial pattern groups. The plurality of serial pattern groups may be connected to each other in parallel. The plurality of serial pattern groups may have a plurality of coil patterns CP connected in series, respectively. The plurality of serial pattern groups may be formed such that the coil patterns formed on adjacent pattern layers from among the plurality of pattern layers are connected to each other in parallel. As a result, the coils formed in the plurality of pattern layers may form a parallel connection relationship, and a large current capacity may be achieved while reducing heating coil loss. The plurality of coil patterns CP respectively forming the plurality of serial pattern groups may be formed in four or more pattern layers. At least one of the plurality of serial pattern groups may have a different combination of the plurality of pattern layers from the other serial pattern groups. Due to these configurations, the wiring structure may be simplified, the number of interlayer connections may be reduced, and accordingly, power loss may be reduced. In other words, the impedance mismatch between the series pattern groups connected in parallel is reduced by the mutual impedance in each pattern layer, and thus, efficiency characteristics equivalent to those of a full-layer series connection structure may be maintained theoretically. In addition, the number of interlayer connections is reduced compared to the full-layer serial connection structure, and thus, the interlayer wiring resistance is reduced, enabling a lower-loss design than the full-layer serial connection structure. At least two of the plurality of serial pattern groups may have the same combination of the plurality of pattern layers. As a result, the number of interlayer connections may be reduced.

In an embodiment of the disclosure, in the heating coil board 10, two terminals (an input terminal 2a and an output terminal 2b) for parallel connecting a plurality of serial pattern groups included in each stacked layer may be formed in outer portions of the coil pattern CP. In addition, electrical connection between the pattern layers may be achieved by a conductor (a through hole TH or a via hole) formed to penetrate the heating coil board 10. The through hole TH penetrate all pattern layers PL and enable electrical connection between the layers.

In addition, in the heating coil board 10 according to an embodiment of the disclosure, the coil patterns CP may be connected such that the input terminal 2a is in the uppermost layer of the plurality of pattern layers PL, and the output terminal 2b is in the lowermost layer of the plurality of pattern layers PL. According to this configuration, when forming the multilayer coil patterns CP, a low-power sensor may be mounted on an upper layer, and the low-power sensor may be easily formed into a thin film structure.

FIG. 9B is a cross-sectional view illustrating interlayer connections of a heating coil board, according to an embodiment of the disclosure.

FIG. 9B is a cross-sectional view illustrating interlayer connections in an eight-layer heating coil board 10, according to an embodiment of the disclosure. Referring to FIG. 9B, the heating coil board 10 may be a PCB formed by stacking four or more pattern layers PL on which coil patterns CP are formed. An insulating layer on which two or more prepreg insulating layers are stacked may be arranged between the pattern layers.

FIG. 9B illustrates the heating coil board 10 formed by stacking eight heating coil pattern layers (first to eighth layers), according to an embodiment of the disclosure. According to an embodiment of the disclosure, the heating coil board 10 includes four heating coil pattern layers 11, 12, 13, and 14, and other four heating coil pattern layers 15, 16, 17, and 18. In an embodiment of the disclosure, the four heating coil patterns 11, 12, 13, and 14 may have four coil patterns CP connected in series, respectively. The four heating coil pattern layers 11, 12, 13, and 14 are connected to each other in parallel via through holes 2c (TH).

In FIG. 9B, assume that the plurality of heating coil pattern layers 11, 12, . . . , 18 are, from the top, the first heating coil pattern layer 11, the second heating coil pattern layer 12, the third heating coil pattern layer 13, the fourth heating coil pattern layer 14, the fifth heating coil pattern layer 15, the sixth heating coil pattern layer 16, the seventh heating coil pattern layer 17, and the eighth heating coil pattern layer 18.

Referring to FIG. 9B, the first heating coil pattern layer 11 may be connected in series to the eighth heating coil pattern layer 18 formed in the eighth layer through a through hole 2d. The second heating coil pattern layer 12 may be connected in series to the seventh heating coil pattern layer 17 formed in the seventh layer through a through hole 2d. The third heating coil pattern layer 13 in the third layer may be connected in series to the sixth heating coil pattern layer 16 formed in the sixth layer through a through hole 2d. The fourth heating coil pattern layer 14 in the fourth layer may be connected in series to the fifth heating coil pattern layer 15 formed in the fifth layer through a through hole 2d.

As such, the heating coil pattern layers 11, 12, 13, and 14 illustrated in FIGS. 9A and 9B have different combinations of pattern layers that are connected in series. In a case in which four heating coil pattern layers 11, 12, 13, and 14 are connected in parallel, the coil patterns CP formed on different pattern layers may be connected in parallel.

In addition, in the heating coil board 10 according to an embodiment of the disclosure, the coil patterns CP may be connected such that the input terminal 2a is in the uppermost layer of the plurality of heating coil pattern layers, and the output terminal 2b is in the lowermost layer of the plurality of heating coil pattern layers. According to this configuration, in a case in which a low-power sensor is mounted in an upper layer when forming the plurality of heating coil pattern layers, it is easy to form the low-power sensor in a thin film structure. The low-power sensor may include a vessel detection coil.

The multilayer structure of the heating coil board 10 is not limited to the eight-layer structure described above.

FIG. 9C is a cross-sectional view illustrating a 16-layer heating coil board and series-parallel connections between layers of the heating coil boards, according to an embodiment of the disclosure.

The connection cross-sectional view of FIG. 9C is the same as FIG. 9B in the stacking method, and in that a plurality of coil patterns connected in series may be provided in one heating coil pattern layer.

One heating coil board 10 may have a plurality of serial pattern groups. The plurality of serial pattern groups may be connected to each other in parallel. The plurality of serial pattern groups may have a plurality of coil patterns CP connected in series, respectively. The plurality of serial pattern groups may be formed such that adjacent pattern layers from among the plurality of heating coil pattern layers are connected to each other in parallel. As a result, coils formed in the plurality of heating coil pattern layers may form a parallel connection relationship, and a large current capacity may be achieved. The plurality of coil patterns CP respectively forming the plurality of serial pattern groups may be formed in four or more pattern layers. At least one of the plurality of serial pattern groups may have a different combination of the plurality of heating coil pattern layers from the other serial pattern groups. According to this, the wiring structure may be simplified, the number of interlayer connections may be reduced, and accordingly, power loss may be reduced. In other words, the impedance mismatch between the series pattern groups connected in parallel is reduced by the mutual impedance in each heating coil pattern layer, and thus, efficiency characteristics equivalent to those of a full-layer series connection structure may be maintained theoretically. In addition, the number of interlayer connections is reduced compared to the full-layer serial connection structure, and thus, the interlayer wiring resistance is reduced, enabling a lower-loss design than the full-layer serial connection structure. At least two of the plurality of serial pattern groups may have the same combination of the plurality of heating coil pattern layers. As a result, the number of interlayer connections may be reduced.

FIG. 9C illustrates the heating coil board 10 formed by stacking 16 heating coil pattern layers (first to sixteenth layers), according to an embodiment of the disclosure. For example, the heating coil board 10 includes four heating coil pattern layers 11, 12, 13, and 14. According to an embodiment of the disclosure, the four heating coil patterns 11, 12, 13, and 14 may include four coil patterns CP connected in series, respectively. The four heating coil pattern layers 11, 12, 13, and 14 are connected to each other in parallel via through holes 2c.

For example, referring to FIG. 9C, the first heating coil pattern layer 11 in the first layer may be connected in series to the heating coil pattern (CP) layer formed in the eighth layer. The second heating coil pattern layer 12 in the second layer may be connected in series to the heating coil pattern (CP) layers formed in the seventh layer, the tenth layer, and the fifteenth layer. The third heating coil pattern layer 13 in the third layer may be connected in series to the heating coil pattern (CP) layers formed in the sixth layer, the eleventh layer, and the fourteenth layer. The fourth heating coil pattern layer 14 in the fourth layer may be connected in series to the heating coil pattern (CP) layers formed in the fifth layer, the twelfth layer, and the thirteenth layer.

As such, the heating coil pattern layers 11, 12, 13, and 14 illustrated in FIG. 9C have different combinations of heating coil pattern layers that are connected in series. In a case in which four heating coil pattern layers 11, 12, 13, and 14 are connected in parallel, the coil patterns CP formed on different heating coil pattern layers are connected in parallel.

According to an embodiment of the disclosure, electrical connection between the heating coil pattern layers is formed by a conductor (a through hole TH) formed to penetrate the heating coil board 10. The through hole TH is formed to penetrate all heating coil pattern layers. Four coil patterns CP forming the respective heating coil pattern layer 11, 12, 13, and 14 may be connected in series by one intermediate terminal 2c formed of a conductor and installed in outer portions of the coil patterns CP, and a plurality of connection terminals 2d formed of a conductor and installed in inner portions of the coil pattern CP.

In addition, in the heating coil board 10 of the present embodiment of the disclosure, the coil patterns CP may be connected such that the input terminal 2a is in the uppermost layer of the plurality of heating coil pattern layers, and the output terminal 2b is in the lowermost layer of the plurality of heating coil pattern layers. According to this configuration, in a case in which a low-power sensor is mounted in an upper layer when forming the plurality of heating coil pattern layers, it is easy to form the low-power sensor in a thin film structure. According to an embodiment of the disclosure, the low-power sensor may include a vessel detection coil as a vessel detection sensor.

FIG. 9D is a cross-sectional view illustrating interlayer connections in a heating coil board including a vessel detection coil layer, according to an embodiment of the disclosure.

The heating coil board 10 of FIG. 9D includes, in the uppermost layer thereof, a vessel detection coil layer 33 including a vessel detection coil.

The vessel detection coil layer 33 according to an embodiment of the disclosure is a pattern layer having printed thereon a plurality of vessel detection coils for detecting the cooking vessel 101 placed on the top plate of the induction heating device 2000.

According to an embodiment of the disclosure, at least two prepreg insulating layers may be included between the vessel detection coil layer 33 and the first heating coil pattern layer 11, to insulate between the two layers while allowing them to be bonded to each other. According to an embodiment of the disclosure, each of the two prepreg insulating layers may be an insulating layer including a resin content of 60% to 80% of the total composition.

According to an embodiment of the disclosure, the heating coil board 10 of FIG. 9D is produced by hot-pressing a multilayer board including the vessel detection coil layer 33, the first to sixteenth heating coil pattern layers, and a signal layer 35 for connector connection that is the lowermost layer. According to an embodiment of the disclosure, during the hot-pressing, a conductor of the vessel detection coil layer 33 in the uppermost layer of the multilayer board or a conductor included in any one of the first to sixteenth heating coil pattern layers does not come into contact with a reinforced fiber of the prepreg insulating layer, and thus, insulation may be maintained.

In an embodiment of the disclosure, a first end of each of the plurality of vessel detection coils included in the vessel detection coil layer 33 may penetrate the heating coil board 10 to be connected to the signal layer 35 for connector connection, which is the lowermost layer, through a through hole 2e. The first end of the vessel detection coil connected through the through hole 2e to the signal layer 35 for connector connection may be connected to a connector mounted on the signal layer 35 for connector connection. In addition, a second end of each of the vessel detection coils may be connected, on the vessel detection coil layer 33, to a terminal of a connector provided on the heating coil board 10. The first end and the second end of each of the plurality of vessel detection coils may be connected to a processor included in the inverter board 30 or an intermediate board 20, through a connector.

In an embodiment of the disclosure, a minimum space, through which the through hole 2e may vertically pass, may be provided in the coil pattern of the heating coil, such that the through hole 2e connected to the first end of each of the vessel detection coils of the vessel detection coil layer 33 does not come into contact with the conductors of the first to sixteenth heating coil pattern layers when passing through the first to sixteenth heating coil pattern layers.

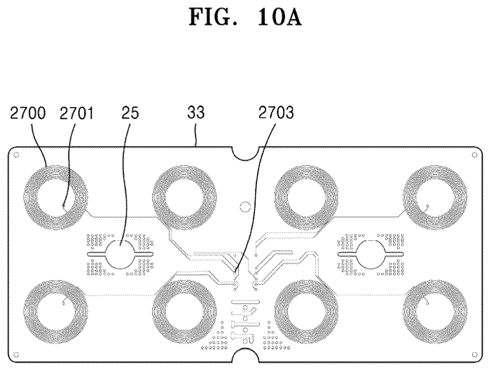

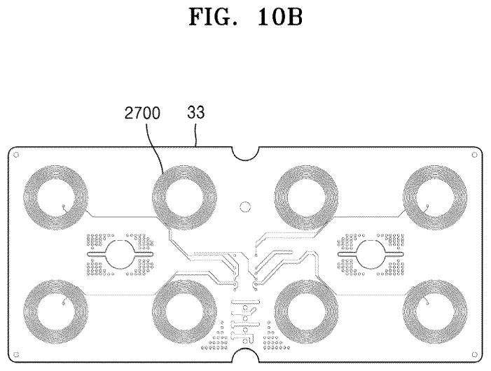

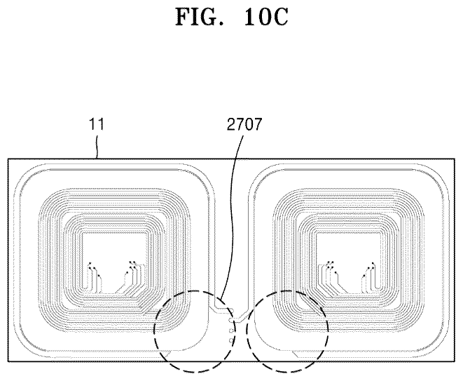

FIG. 10A illustrates a pattern layer including a vessel detection coil, according to an embodiment of the disclosure.

FIG. 10A illustrates the vessel detection coil layer 33 including vessel detection coils 2700 in the heating coil board 10.

The vessel detection coil layer 33 of FIG. 10A includes eight vessel detection coils 2700 as patterns. In addition, according to an embodiment of the disclosure, the vessel detection coil layer 33 includes a hole 25 through which a temperature sensor capable of sensing the temperature of a cooking vessel may pass. In some cases, the hole 25 through which a temperature sensor may pass may not be included in the vessel detection coil layer 33. In the vessel detection coil layer 33 of FIG. 10, the pattern of the vessel detection coil 2700 has a circular shape, and may be provided in a plane space that vertically overlaps with a heating coil patterned in another layer as little as possible. The reason why the vessel detection coil 2700 and the heating coil need to vertically overlap with each other as little as possible is because the power level of the heating coil is high. The heating coil with a high power level may affect a detection operation of the vessel detection coil 2700 with a relatively low power level. Thus, in an embodiment of the disclosure, the vessel detection coil may be printed as close to an edge as possible on a diagonal line of the board on which the vessel detection coil is printed, and the heating coil may be printed in the center of the board on which the heating coil is printed.

The vessel detection coil 2700 may include a first end 2701 that extends down to the signal layer 35 for connector connection, which is the lowermost layer of the heating coil board 10, through a through hole or a via hole in the center of a circle in which the vessel detection coil 2700 is applied for patterning, and a second end 2703 for connecting to a connector or a wire provided on the vessel detection coil layer 33. The induction heating device 2000 may detect whether a vessel is on a top plate 5 of the induction heating device 2000, through a change in inductance measured by the vessel detection coil 2700 through the first end 2701 and the second end 2703. This is only an example, and in a case in which the heating coil board 10 does not include a separate signal layer 35 for connector connection and a lower portion of the lowermost heating coil pattern layer may be used as a printed pattern, the first end that extends down to the lowermost layer of the heating coil board 10 through the through hole may be connected to a connector or a wire at the lower portion of the lowermost heating coil pattern layer.

FIG. 10B is a diagram illustrating a vessel detection coil layer, according to an embodiment of the disclosure.

FIB. 10B illustrates the vessel detection coils 2700 are printed on the vessel detection coil layer 33.

FIG. 10C is a diagram illustrating a heating coil pattern layer, according to an embodiment of the disclosure.

Assume that the heating coil pattern layer of FIG. 10C is the first heating coil pattern layer 11, which is one of a plurality of heating coil pattern layers. The vessel detection coil layer 33 of FIG. 10B and the first heating coil pattern layer 11 of FIG. 10C may be stacked to constitute a part of a multilayer board. When the multilayer board is hot-pressed, the heating coil board 10 may be produced.

The vessel detection coil 2700 on the vessel detection coil layer 33 of FIG. 10B may be printed in an area 2707 of FIG. 10C that vertically overlaps with the heating coil of the first heating coil pattern layer 11 as little as possible. As the vessel detection coil 2700 of FIG. 10B is printed in the area 2707 of FIG. 10C that vertically overlaps with the heating coil as little as possible, the vessel detection coil 2700 with a low power level may minimize electrical interference from the heating coil with a high power level.

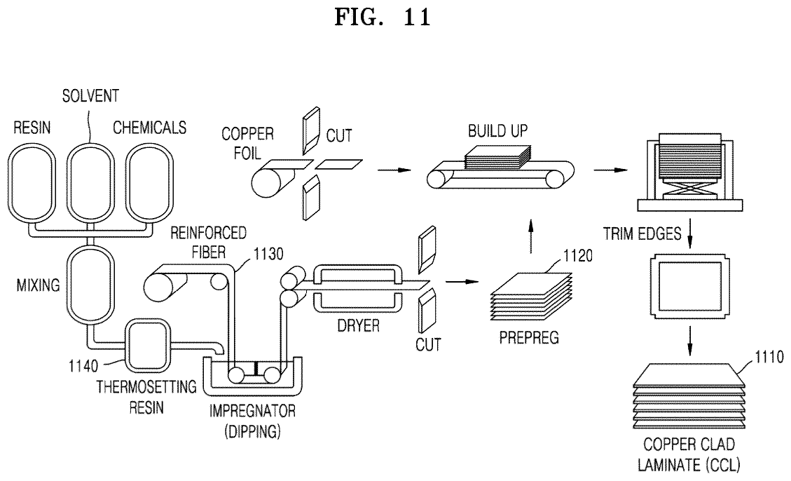

FIG. 11 illustrates a process of producing a heating coil board of an induction heating device, according to an embodiment of the disclosure.

FIG. 11 illustrates a final production process of a copper clad laminate (CCL) 1110. The CCL is a PCB substrate formed by stacking a plurality of heating coil pattern layers. The CCL may be produced with a copper foil bonded to one or both sides of a PCB core. The CCL is formed by stacking copper foils on a prepreg (preimpregnated material) 1120.

The prepreg 1120 is a sheet-shaped resin product in which a matrix is impregnated into a reinforced fiber 1130 in advance, and is made into a semi-cured state by infiltrating the reinforced fiber 1130 into a thermosetting resin 1140. The prepreg is an insulating material, but also used as an adhesive to bond each heating coil pattern layer.

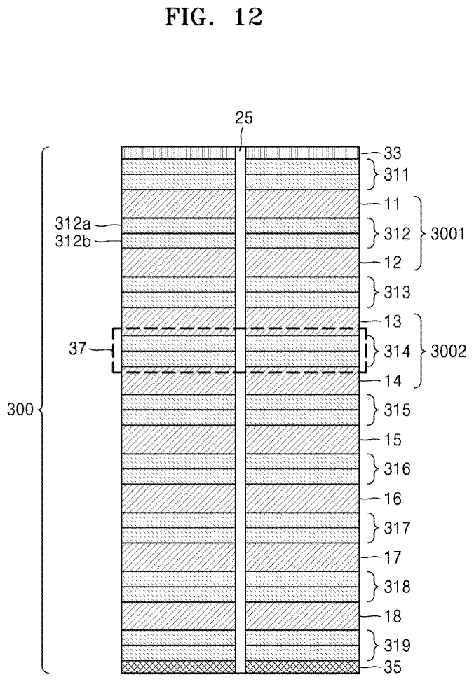

FIG. 12 is a diagram illustrating a heating coil board layer by layer, according to an embodiment of the disclosure.

Referring to FIG. 12, a multilayer board 300 according to an embodiment of the disclosure may include a plurality of heating coil pattern layers, for example, eight heating coil pattern layers 11, 12, . . . , 18, and a plurality of insulating layers, for example, nine insulating layers 311, 312, . . . , 319. One insulating layer 312 includes, for example, two prepreg insulating layers 312a and 312b. The heating coil board 10 is produced by hot-pressing the multilayer board 300.

In FIG. 12, a PCB substrate used to produce a board forming one heating coil pattern layer 11 has a size of 1020 (mm)×1200 (mm) or 1020 (mm)×1020 (mm). When producing a board by printing a heating coil pattern on a PCB substrate, in order to supply high power while reducing a skin effect, it is necessary to decrease the thickness of copper patterned as a conductor and the width of the heating coil pattern. At the same time, a current capacity may be achieved by connecting the plurality of heating coil pattern layers 11, 12, . . . , 18 in parallel. However, in order to connect the plurality of heating coil pattern layers 11, 12, . . . , 18 in parallel, the number of interlayer connections increases and coil loss due to the wiring length also increases. In order to reduce the number of interlayer connections while reducing coil loss, a plurality of serial patterns connected in series may be provided among the plurality of heating coil pattern layers 11, 12, . . . , 18. In addition, the plurality of serial patterns may be connected to each other in parallel. In an embodiment of the disclosure, it is preferable that at least one serial pattern is stacked in four or more layers.

According to an embodiment of the disclosure, the upper four layers 11, 12, 13, and 14 from among the plurality of heating coil pattern layers 11, 12, . . . , 18 may be electrically connected to each other in parallel. In addition, the lower four layers 15, 16, 17, and 18 from among the plurality of heating coil pattern layers 11, 12, . . . , 18 may be electrically connected to each other in parallel. Here, although ‘upper’ and ‘lower’ are relative terms, ‘upper heating coil pattern layers’ may refer to those closer to the top plate of the induction heating device 2000 from among the plurality of heating coil pattern layers 11, 12, . . . , 18.

Four heating coil pattern layers electrically connected to each other in parallel may be connected to each other in series. The serial connection between the heating coil pattern layers may be made between the first heating coil pattern layer 11 and the eighth heating coil pattern layer 18, between the second heating coil pattern layer 12 and the seventh heating coil pattern layer 17, between the third heating coil pattern layer 13 and the sixth heating coil pattern layer 16, and between the fourth heating coil pattern layer 14 and the fifth heating coil pattern layer 15. Detailed descriptions thereof are provided above with reference to FIG. 10B.

However, this is only an embodiment of the disclosure, and in a case in which only the first heating coil pattern layer 11 to the fourth heating coil pattern layer 14 are provided, the first heating coil pattern layer 11 and the second heating coil pattern layer 12 may be electrically connected to each other in parallel, and the third heating coil pattern layer 13 and the fourth heating coil pattern layer 14 may be electrically connected to each other in parallel. In addition, the first heating coil pattern layer 11 and the fourth heating coil pattern layer 14 may be electrically connected to each other in series, and the second heating coil pattern layer 12 and the third heating coil pattern layer 13 may be electrically connected to each other in series.

In an embodiment of the disclosure, the thickness of each of the plurality of heating coil pattern layers 11, 12, . . . , 18 may be about 60 μm to about 82 μm.

In an embodiment of the disclosure, the thickness of the heating coil board 10 formed by hot-pressing the multilayer board 300 including the vessel detection coil layer 33, the signal layer 35 for connector connection, and 18 heating coil pattern layers may be 3.3 mm or less. However, this is only an embodiment of the disclosure, and the thickness of the heating coil board 10 formed by hot-pressing the multilayer board 300 may be about 2.5 mm to about 4.0 mm.

When a manufacturer of the induction heating device 2000 orders CCLs, the CCL may be produced to include two heating coil pattern layers and an insulating layer therebetween. In this case, an insulating layer may be inserted between a plurality of CCLs to produce the multilayer board 300. Here, the insulating layer may be produced by stacking two prepreg insulating layers.

Referring to FIG. 12, a first CCL 3001 may include the first heating coil pattern layer 11, the insulating layer 312, and the second heating coil pattern layer 12. A second CCL 3002 may include the third heating coil pattern layer 13, an insulating layer 314, and the fourth heating coil pattern layer 14. When the manufacturer of the induction heating device 2000 obtains the ordered CCLs, insulating layers may be stacked between the CCLs to produce the multilayer board 300. For example, an insulating layer 313 may be inserted between the first CCL 3001 and the second CCL 3002. The insulating layer 313 may be produced by stacking two prepreg insulating layers.

Finally, when the multilayer board 300 is hot-pressed, the CCLs are hardly hot-pressed because they have already been hot-pressed, and instead, the compression ratio of the insulating layer between the CCLs (e.g., the insulating layer 313) is high. In an embodiment of the disclosure, the insulating layer inside the CCL (e.g., the insulating layer 312) may have a thickness of 140 μm or less after hot-pressing. On the contrary, the insulating layer between the CCLs (e.g., the insulating layer 313) may have a thickness of 120 μm or less after hot-pressing.

FIG. 12 illustrates eight heating coil pattern layers, but this is only an embodiment of the disclosure, and according to an embodiment of the disclosure, the number of heating coil pattern layers may be adjusted according to a design. For example, the number of heating coil pattern layers may be four. Alternatively, in an embodiment of the disclosure, a heating coil board may be used, in which eight CCLs are stacked, each of which includes two heating coil pattern layers and an insulating layer therebetween, to form a total of 16 heating coil pattern layers.

As illustrated in FIG. 12, in a case in which a heating coil is applied to pattern a PCB, the manufacturing process may be simplified and the manufacturing cost may be reduced compared to a case in which a heating coil is produced by winding a Litz wire. In addition, in a case in which a heating coil is applied to pattern a PCB, the inductance accuracy of the heating coil is higher than when a heating coil is produced by winding a Litz wire, and thus, a constant heating level may be achieved.

In addition, patterning a PCB with a heating coil reduces copper usage to one-third compared to when a heating coil is produced by winding a Litz wire for the same heating output, and thus, the copper consumption may be reduced.

In a case in which one ounce (oz) of copper is used for a PCB substrate (1020(mm)×1200 (mm) or 1020 (mm)×1020 (mm)) to be used to produce a heating coil pattern layer, insulation may be achieved between the plurality of insulating layers 311, 312, . . . , 319 and the plurality of heating coil pattern layers 11, 12, . . . , 18 when hot-pressing a multilayer board on which the PCB substrate is stacked, however, the amount of copper may be insufficient for a heating coil required for high power. The insufficient amount of copper may cause overheating in the heating coil pattern and increase heat loss. In order to reduce heat generated from a heating coil pattern, a method of increasing the width of the heating coil pattern may be used, however, increasing the pattern width makes it difficult to achieve a large number of turns and therefore an appropriate inductance, making it challenging in terms of design. Thus, there is an option to increase the thickness of the heating coil pattern.

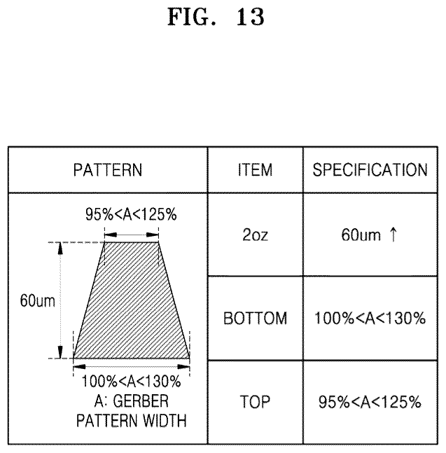

FIG. 13 is a diagram showing specifications for heating coil pattern widths, according to an embodiment of the disclosure.

Unlike copper patterns of general PCBs, heating coil patterns need to handle a large power capacity. Thus, because a large amount of current needs to flow through a heating coil applied for patterning, the width of the pattern needs to be greater than that of a normal copper pattern, or the thickness (height) of the pattern needs to be high.

In order to increase the thickness of a heating coil pattern, 2 ounces (oz) of copper may be used on a PCB substrate instead of 1 ounce (oz) of copper that is used in the related art.

FIG. 13 illustrates a cross-sectional view of a copper pattern with 2 ounces of copper on a PCB substrate. As seen in FIG. 13, the height of the copper pattern is 35 μm when 1 ounce of copper is used, whereas the height is 60 μm or greater when 2 ounces of copper are used. The width (Gerber width) is a width requested by a customer who produces the induction heating device 2000, and an upper portion of the pattern may be between 95% and 125% of an ordered width A, and a lower portion of the pattern may be between 100% and 130% of the ordered width A. In general, when copper in a liquid state is melted, it takes the shape of a trapezoid with slightly different widths at the top and bottom as illustrated in FIG. 13.

However, when 2 ounces (oz) or greater (e.g.,2 ounces to 3 ounces) of copper is used on a PCB substrate, the copper becomes too thick, and thus, when hot-pressing the multilayer board 300 of FIG. 12, an issue may occur in which one prepreg insulating layer 312a is pressed in a liquefied state and comes into contact with a copper coil.

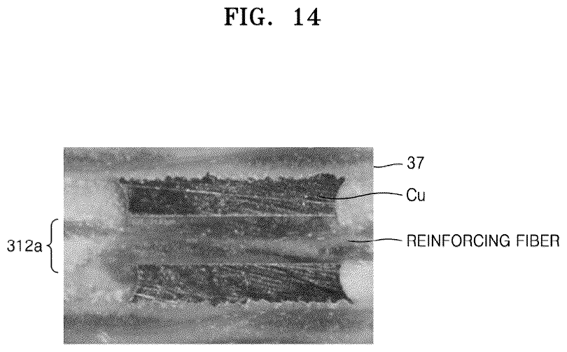

FIG. 14 shows a partial cross-section 37 of the heating coil illustrated in FIG. 12.

FIG. 14 is a diagram showing a partial cross-section of a multilayer board according to an embodiment of the disclosure.

Referring to the partial cross-section 37 of the heating coil, a phenomenon occurs in which copper comes into contact with a reinforced fiber included in an intermediate insulating material due to hot-pressing. Thus, according to an embodiment of the disclosure, in order to prevent the phenomenon in which copper comes into contact with the reinforced fiber as shown in FIG. 14, an insulating layer in which at least two prepreg layers are stacked is used. In an embodiment of the disclosure, the at least two prepreg layers may have a thickness of less than or equal to about 140 μm before hot-pressing. In an embodiment of the disclosure, the at least two prepreg layers need to have a thickness of 130 μm or less, or 140 μm or less before hot-pressing, such that the thickness of the heating coil board after hot-pressing is 3.3 mm or less.

One prepreg insulating layer 312a includes a resin content, which may flow out when making the PCB multilayer and hot-pressing the multilayer PCB. The resin content flowing out as described above comes into contact with the reinforced fiber included in the prepreg insulating layer 312a, causing a part where the adhesiveness is reduced. When the bonding between pattern layers by the prepreg insulating layer 312a is not properly performed, the heating coil pattern comes off internally as a current flows through the heating coil, and when the heating coil pattern comes off, moisture or air infiltrates thereinto, causing the PCB to swell. In order to prevent this phenomenon, a method of stacking two prepreg insulating layers 312a and 312b as insulating layers between heating coil pattern layers, as illustrated in FIG. 12, may be used.

An insulating layer with a resin content of 60% (RC60) to 80% (RC80) is used as one prepreg insulating layer, and two or more prepreg insulating layers 312a and 312b are stacked. The thickness of any one of the prepreg insulating layer 312a and 312b before hot-pressing may be 70 μm or less. Thus, the prepreg insulating layers 312a and 312b may have a thickness of 130 μm or less, or 140 μm or less before hot-pressing. ‘With a resin content of 60% (RC60) to 80% (RC80)’ means that resin accounts for 60% to 80% of the total composition of a compound included in the prepreg insulating layer.

Hereinafter, descriptions will be provided with reference to FIG. 12.

Each layer constituting the multilayer board 300 according to an embodiment of the disclosure may include the hole 25 through which a temperature sensor may pass. The temperature sensor may sense the temperature of the cooking vessel 101 placed on the top plate of the induction heating device 2000.

According to an embodiment of the disclosure, the uppermost layer of the multilayer board 300 may include the vessel detection coil layer 33 that includes only a vessel detection coil for detecting whether a cooking vessel is placed on the top plate 5 of the induction heating device 2000. This is only an embodiment of the disclosure, and the vessel detection coil may be applied for patterning and included, together with the heating coil, in the first heating coil pattern layer 11, which is the uppermost layer among the plurality of heating coil pattern layers 11, 12, . . . , 18. When the vessel detection coil is applied for patterning the heating coil pattern layer, induced power may be transferred to the vessel detection coil by a heating coil. Thus, according to an embodiment of the disclosure, the multilayer board 300 may be designed such that a vessel detection coil is included in the vessel detection coil layer 33 separate from the heating coil pattern layers. According to an embodiment of the disclosure, the vessel detection coil layer 33 may have a thickness of 110 μm or less after hot-pressing.

The insulating layer 311 including two prepreg insulating layers may be arranged between the vessel detection coil layer 33 and the first heating coil pattern layer 11, for insulation and adhesion. The insulating layer 311 arranged between the vessel detection coil layer 33 and the first heating coil pattern layer 11 may be thinner than the insulating layer 312 including two prepreg insulating layers and arranged between the first heating coil pattern layer 11 and the second heating coil pattern layer 12. In an embodiment of the disclosure, the thickness of the insulating layer 311 arranged between the vessel detection coil layer 33 and the first heating coil pattern layer 11 may be 130 μm or less. In addition, the amount of copper (0.5 oz to 1 oz) used in the PCB substrate to produce the vessel detection coil layer 33 may be less than the amount of copper (2 to 3 oz) used in the heating coil pattern layer. This is because the vessel detection coil of the vessel detection coil layer 33 is used for sensing a cooking vessel, and thus, the amount of copper used in the vessel detection coil may be less than that in the heating coil for high power.

The vessel detection coil included in the vessel detection coil layer 33 may detect whether the cooking vessel 101 is placed on the top plate of the induction heating device 2000. When the vessel detection coil of the induction heating device 2000 detects the cooking vessel 101, the processor of the induction heating device 2000 may display information such as identification information of the cooking vessel 101, location information of the cooking vessel 101, a presence or absence of the cooking vessel 101, or a material of the cooking vessel 101 detected through the vessel detection coil, on a display included in a user interface.

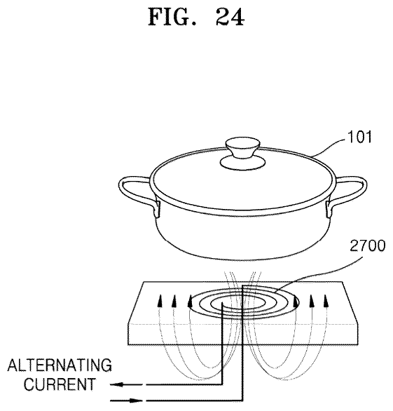

A method of detecting the material of the cooking vessel 101 will be described with reference to FIG. 24.

FIG. 24 illustrates a vessel detection coil detecting a material of a cooking vessel, according to an embodiment of the disclosure.

When the cooking vessel 101 is placed on the vessel detection coil 2700, a change occurs in a magnetic field generated by the vessel detection coil 2700. At this time, as the cooking vessel 101 with a high magnetic permeability (μ1) approaches the vessel detection coil 2700, the total inductance generated by the vessel detection coil 2700 increases, and accordingly, a current i₁ flowing in the vessel detection coil 2700 decreases. When the magnetic permeability of the cooking vessel 101 is relatively low (μ2<μ1), the total inductance generated by the vessel detection coil 2700 is relatively reduced, and accordingly, a current i₂ flowing in the vessel detection coil 2700 increases compared to the current is in the above case. According to this change in current, the induction heating device 2000 may determine the material of the cooking vessel 101 through the vessel detection coil 2700.

According to an embodiment of the disclosure, the vessel detection coil layer 33 may include a temperature sensor for sensing the temperature of the heating coil board 10 when the induction heating device 2000 heats the cooking vessel 101.

A memory included in the induction heating device 2000 may store instructions, when executed by one or more processors included in the induction heating device 2000 individually or collectively, causing the induction heating device 2000 to determine the material of the cooking vessel 101. The instructions, when executed by one or more processors included in the induction heating device 2000 individually or collectively, also may cause the induction heating device 2000 to determine a position of the cooking vessel 101 on the top plate, or a presence or absence of the cooking vessel 101.

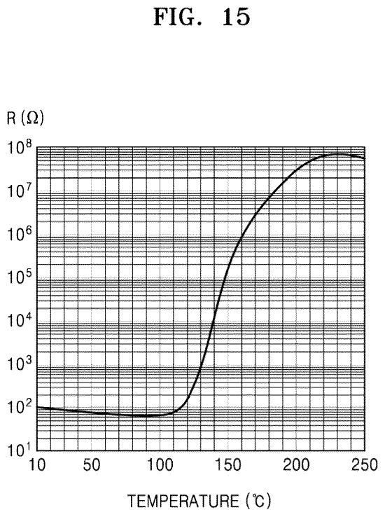

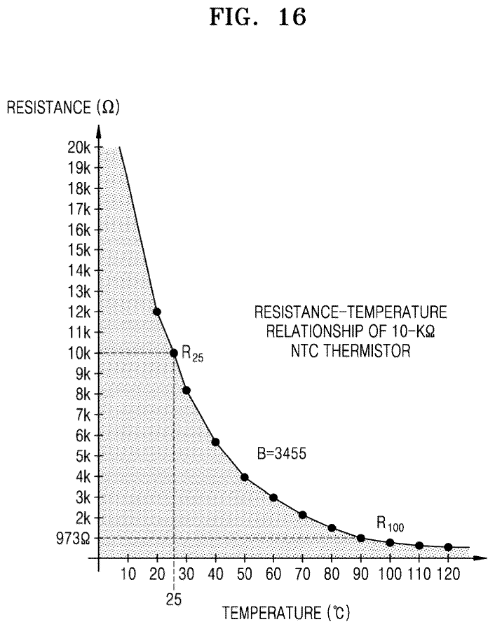

FIGS. 15 and 16 show characteristic curves of a temperature sensor according to an embodiment of the disclosure.

The temperature sensor may include a positive temperature coefficient (PTC) thermistor or a negative temperature coefficient (NTC) thermistor. FIG. 15 shows a characteristic curve of a PTC thermistor according to an embodiment of the disclosure.

Referring to FIG. 15, the PTC thermistor has a characteristic in which the resistance increases as the temperature of an area where the PTC thermistor is attached increases. For example, the PTC thermistor has a resistance of 1 kΩ when the detected temperature is about 130° C. In addition, the PTC thermistor has a resistance of 100 Ω or less when the detected temperature is about 100° C. The PTC thermistor according to FIG. 15 is only an example, and the temperature-resistance characteristic curve of the PTC thermistor may vary depending on the type of the PTC thermistor.

FIG. 16 is a characteristic curve of an NTC thermistor according to an embodiment of the disclosure.

Referring to FIG. 16, the NTC thermistor has a characteristic in which the resistance decreases as the temperature of an area where the NTC thermistor is attached increases. For example, the NTC thermistor has a resistance of 973 Ω when the detected temperature is about 100° C. In addition, the NTC thermistor has a resistance of 10 kΩ when the detected temperature is about 25° C. The NTC thermistor according to FIG. 16 is only an example, and the temperature-resistance characteristic curve of the NTC thermistor may also vary depending on the type of the NTC thermistor.

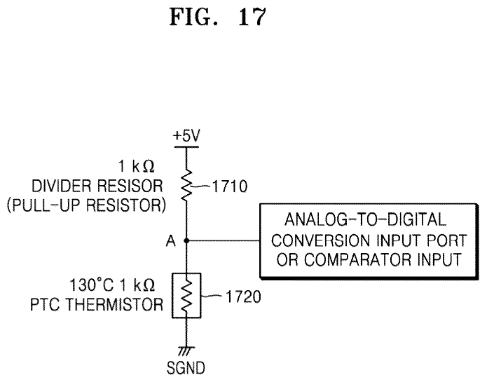

FIG. 17 illustrates a temperature sensing circuit according to an embodiment of the disclosure.

FIG. 17 illustrates a temperature sensing circuit using a thermistor as a temperature sensor, according to an embodiment of the disclosure.

The temperature sensing circuit of FIG. 17 may include a divider resistor 1710 and a PTC thermistor 1720 as a temperature sensor, and an output point A of the temperature sensing circuit may be input to an analog-to-digital conversion input port. This is only an embodiment of the disclosure, and the output point A of the temperature sensing circuit may be directly input to, for example, a processor (not shown) having an analog-to-digital conversion input port, or may be input to a comparator to be compared with a certain value. The PTC thermistor 1720 detects the temperature of the heating coil board 10.

Referring to FIG. 17, an input voltage of +5 V is distributed by the 1-kΩ divider resistor 1710 and the PTC thermistor 1720. The divider resistor 1710 is a resistor that distributes the input voltage of +5V, with the PTC thermistor 1720. In addition, it may be seen in FIG. 17 that the divider resistor 1710 is a pull-up resistor. The point A between the divider resistor 1710 and the PTC thermistor 1720 is connected to an analog-to-digital conversion input port or a comparator input. FIG. 17 illustrates one divider resistor 1710, but a plurality of divider resistors 1710 may be used. FIG. 17 illustrates that the PTC thermistor 1720 has a resistance of 1 kΩ at 130° C., but the resistance by temperature may vary depending on the type of the PTC thermistor 1720. Referring to FIG. 17, a voltage applied to the point A at 130° C. is 2.5 V. Assume that a temperature at which the heating coil board 10 is determined to be overheated is 130° C. When the resistance of the PTC thermistor 1720 is 1 kΩ at 130° C., the voltage applied to the point A is 2.5 V. Thus, the processor (not shown) that has detected a digital value corresponding to 2.5 V may determine that the heating coil board 10 is overheated. A processor that has determined that the heating coil board 10 is overheated may subsequently perform an overheating prevention operation. The temperature at which the heating coil board 10 is determined to be overheated may be arbitrarily selected by the designer according to the specifications of the material of the heating coil board 10. As such, the point A, at which a voltage value that changes due to a change in the resistance of the PTC thermistor 1720 according to a change in temperature is read, may be referred to as an output of the temperature sensing circuit.

According to an embodiment of the disclosure, when a temperature detected by the temperature sensor included in the heating coil board 10 is greater than or equal to a preset temperature (e.g., when a temperature detected in a heating coil pattern layer is 130° C.), the induction heating device 2000 may lower the output of the induction heating device 2000. Assume that the output of the induction heating device 2000 is divided into levels 1 to 10 and that the induction heating device 2000 is currently performing a heating operation at level 10. For example, when the temperature of the heating coil pattern layer is detected as 130° C. by the temperature sensor, the induction heating device 2000 may automatically lower the output to level 9. When the temperature of the heating coil pattern layer does not decrease to 130° C. or less within a preset time period (e.g., 30 seconds) even though the induction heating device 2000 has lowered the output to level 9, the induction heating device 2000 may automatically further lower the output to level 8.

On the contrary, when the temperature of the heating coil pattern layer decreases to a second preset temperature (e.g., 90° C.) or less while the output is at level 8, the induction heating device 2000 may raise the output back to level 9. In this manner, the output of the induction heating device 2000 may be adjusted according to the temperature of the heating coil pattern layer through the temperature sensor. In an embodiment of the disclosure, adjustment of the output of the induction heating device 2000 may be performed by the processor (not shown) of the induction heating device 2000.

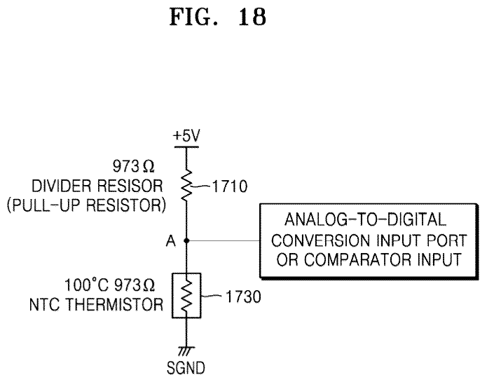

FIG. 18 illustrates a temperature sensing circuit according to an embodiment of the disclosure.

The temperature sensing circuit of FIG. 18 may include the divider resistor 1710 and an NTC thermistor 1730 as a temperature sensor, and an output point B of the temperature sensing circuit may be input to an analog-to-digital conversion input port or a comparator.

The NTC thermistor 1730 may be used to detect the temperature of the heating coil board 10. The divider resistor 1710 is a resistor that distributes the input voltage of +5V, with the NTC thermistor 1730.

Referring to FIG. 18, an input voltage of +5 V is distributed by the 973-Ω divider resistor 1710 and the NTC thermistor 1730. In FIG. 18, the divider resistor 1710 is a pull-up resistor. The point B between the divider resistor 1710 and the NTC thermistor 1730 is connected to an analog-to-digital conversion input port, or in a case in which the processor (not shown) has an analog-to-digital conversion input port, to the analog-to-digital conversion input port of the processor (not shown) or an input of a comparator. FIG. 18 illustrates one divider resistor 1710, but a plurality of divider resistors 1710 may be used. FIG. 18 illustrates that the NTC thermistor 1730 has a resistance of 973 Ω at 100° C., but the resistance by temperature may vary depending on the type of the NTC thermistor 1730. Assume that a temperature at which the heating coil board 10 is determined to be overheated is 100° C. Referring to FIG. 18, when the resistance of the NTC thermistor 1730 is 973 Ω at 100° C., the voltage applied to the point B is 2.5 V. Thus, the processor that has detected a digital value corresponding to 2.5 V may determine that the heating coil board 10 is overheated. When it is determined that the heating coil board 10 is overheated, the processor may optionally perform an overheating prevention operation. The temperature at which the heating coil board 10 is determined to be overheated may be arbitrarily selected by the designer according to the specifications of the heating coil board 10. As such, the point B, at which a voltage value that changes according to the NTC thermistor 1730 is read, may be referred to as an output of the temperature sensing circuit.

According to an embodiment of the disclosure, when a temperature detected by the temperature sensor included in the vessel detection coil layer 33 is greater than or equal to a preset temperature (e.g., when a temperature detected in a heating coil pattern layer is 100° C.), the induction heating device 2000 may lower the output of the induction heating device 2000. Assume that the output of the induction heating device 2000 is divided into levels 1 to 10 and that the induction heating device 2000 is currently performing a heating operation at level 8. For example, when the temperature of the heating coil pattern layer is detected as 100° C. by the temperature sensor, the induction heating device 2000 may automatically lower the output to level 7. When the temperature of the heating coil pattern layer does not decrease to 100° C. or less within a preset time period even though the induction heating device 2000 has lowered the output to level 7, the induction heating device 2000 may automatically further lower the output to level 6.

On the contrary, when the temperature of the heating coil pattern layer decreases to a second preset temperature (e.g., 80° C.) or less while the output is at level 7, the induction heating device 2000 may raise the output back to level 8. In this manner, the output of the induction heating device 2000 may be adjusted according to the temperature of the heating coil pattern layer through the temperature sensor. In an embodiment of the disclosure, adjustment of the output of the induction heating device 2000 may be performed by the processor (not shown) of the induction heating device 2000.

Referring back to FIG. 12, according to an embodiment of the disclosure, the lowermost layer of the multilayer board 300 may include the signal layer 35 for connector connection on which a connector is mounted to connect the heating coil board 10 to the inverter board of the induction heating device 2000 with a connector. According to an embodiment of the disclosure, the signal layer 35 for connector connection may have a thickness of 110 μm or less after hot-pressing. The insulating layer 319 in which two prepreg insulating layers are stacked for insulation and adhesion may be arranged between the signal layer 35 for connector connection and the eighth heating coil pattern layer 18. The insulating layer 319 in which two prepreg insulating layers are stacked, which is arranged between the signal layer 35 for connector connection and the eighth heating coil pattern layer 18, may be thinner than an insulating layer 318 in which two prepreg insulating layers are stacked, which is arranged between the seventh heating coil pattern layer 17 and the eighth heating coil pattern layer 18. In an embodiment of the disclosure, in a case in which the thickness of the insulating layer 319 arranged between the signal layer 35 for connector connection and the eighth heating coil pattern layer 18 is 120 μm or less, the thickness of the insulating layer 318 arranged between the seventh heating coil pattern layer 17 and the eighth heating coil pattern layer 18 may be slightly greater, 130 μm or less. In addition, the amount of copper (0.5 oz to 1 oz) used in the PCB substrate to produce the signal layer 35 for connector connection may be less than the amount of copper (2 to 3 oz) used in the heating coil pattern layer. This is because a signaling coil of the signal layer 35 for connector connection is used for signal transmission, and thus, the amount of copper used in the signal layer 35 for connector connection may be less than that in the heating coil for high power.

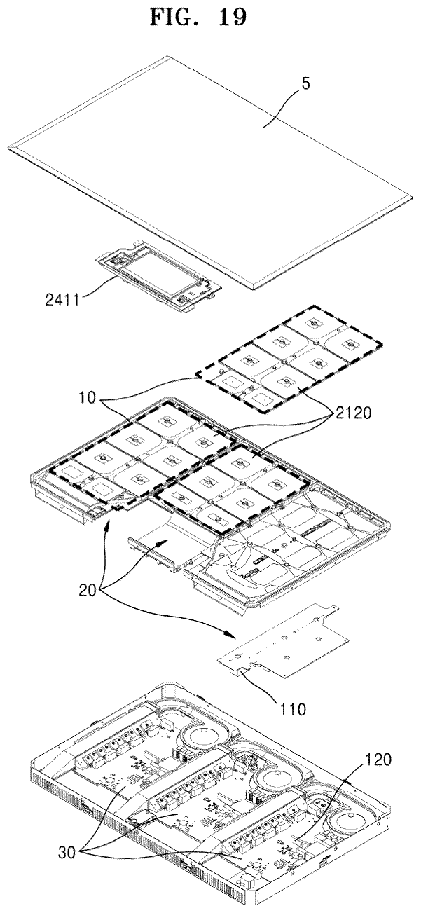

Mounting of a connector for connection between boards such as the heating coil board 10 and an inverter board will be described with reference to FIGS. 19 to 21.

FIG. 19 illustrates a structure in which boards of an induction heating device are connected to each other, according to an embodiment of the disclosure.

Referring to FIG. 19, the induction heating device 2000 according to an embodiment of the disclosure may include the top plate 5 on which the cooking vessel 101 is to be placed, and the heating coil board 10 that is patterned with a plurality of heating coils stacked thereon, and arranged under the top plate 5. The induction heating device 2000 according to an embodiment of the disclosure may include the intermediate board 20 including a relay, a resonant capacitor, and the like, and arranged under the heating coil board 10. In an embodiment of the disclosure, the intermediate board 20 may include a memory storing a program for controlling an operation of the induction heating device 2000, and a processor configured to execute the program stored in the memory to control the induction heating device 2000.

The induction heating device 2000 according to an embodiment of the disclosure may include the inverter board 30 including an inverter and a power conversion device, and arranged under the intermediate board 20. According to an embodiment of the disclosure, the resonant capacitor may be included in the inverter board 30. In an embodiment of the disclosure, depending on design specifications, the intermediate board 20 and the inverter board 30 may be integrated into one inverter board. The inverter board 30 may include a plurality of electronic switches that constitute an inverter. The plurality of electronic switches perform pulse-width modulation (PWM) switching. The PWM switching may induce eddy currents in the cooking vessel 101 by causing resonance between the heating coil 2120 included in the heating coil board 10, and the resonant capacitor. The inverter board 30 may include a power conversion device configured to generating a low-voltage direct current used for the processor, the memory, and the like included in the intermediate board 20. The power conversion device may also generate a voltage of +15 V or +12 V for switching of the plurality of electronic switches of the inverter. In the disclosure, the power conversion device may be referred to as a switched-mode power supply (SMPS).

In an embodiment of the disclosure, as a first connector 110 mounted vertically on a lower surface of the intermediate board 20 is accommodated in a second connector 120 mounted vertically on an upper surface of the inverter board 30, the intermediate board 20 may be electrically connected to the inverter board 30. In an embodiment of the disclosure, the electrical connection between the intermediate board 20 and the inverter board 30 may be made through only connection between the first connector 110 and the second connector 120.

In an embodiment of the disclosure, the first connector 110 mounted vertically on the lower surface of the intermediate board 20 may be a male connector, and the second connector 120 mounted vertically on the upper surface of the inverter board 30 may be a female connector. In an embodiment of the disclosure, the first connector 110 mounted vertically on the lower surface of the intermediate board 20 may be a female connector, and the second connector 120 mounted vertically on the upper surface of the inverter board 30 may be a male connector.

When the heating coil board 10, the intermediate board 20, and the inverter board 30 are connected to each other as illustrated in FIG. 19, wires for connecting between the boards are no longer needed, and thus, product defects due to wires do not occur. In addition, it does not cause any inconvenience in assembly or increase in manufacturing costs due to wires. Thus, the structure in which the boards are connected to each other by connectors as illustrated in FIG. 19 may simplify product assembly and minimize product defects. This structure is possible because the heating coils are applied for patterning, and thus, the heating coil board 10 may be connected to the inverter board 30 through only a connector, as illustrated in FIG. 19.

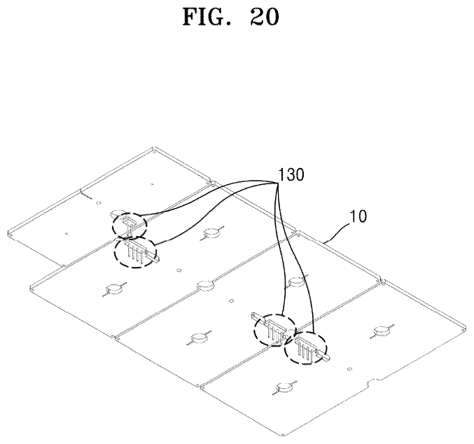

FIG. 20 is a diagram illustrating a structure in which connectors are connected to a heating coil board in an induction heating device, according to an embodiment of the disclosure.

FIG. 20 illustrates a lower surface of the heating coil board 10 on which heating coil board connectors 130 are mounted, not an upper surface on which the top plate 5 is arranged. On the lower surface of the heating coil board 10, the heating coil board connectors 130 are vertically mounted such that each heating coil 2120 is electrically connected to an inverter 2113. The heating coil board connector 130 may be a male connector or a female connector. In the disclosure, the heating coil board connector 130 may be referred to as a third connector to distinguish it from the first connector 110 and the second connector 120 illustrated in FIG. 19. In an embodiment of the disclosure, the heating coil board connector 130 may have a structure that is directly connected to a connector mounted vertically on the inverter board 30 through a hole in the intermediate board 20 of FIG. 19. Alternatively, in an embodiment of the disclosure, the heating coil board connector 130 may be connected to a fourth connector mounted on the intermediate board 20. In an embodiment of the disclosure, in a case in which the intermediate board 20 has a resonant capacitor 2114 mounted thereon, the heating coil board connector 130 is connected to the fourth connector of the intermediate board 20.

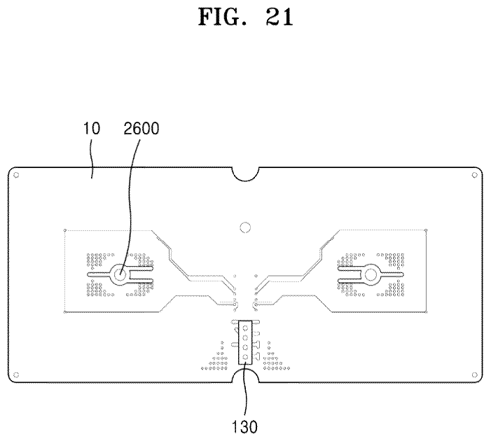

FIG. 21 is a diagram illustrating a structure in which a connector is mounted on a rear surface of a heating coil board in an induction heating device, according to an embodiment of the disclosure.

FIG. 21 illustrates a lower surface of the heating coil board 10, like FIG. 20. The heating coil board 10 of FIG. 21 has a hole penetrating the entire heating coil board 10 in a central portion where the heating coil 2120 is printed for patterning, and the temperature sensor 2600 is installed in the hole. The temperature sensor 2600 may be used to measure the temperature of the cooking vessel 101 placed on the top plate 5 of the induction heating device 2000.

The heating coil board 10 has the heating coil board connector 130 mounted vertically thereon to be electrically connected to the intermediate board 20 and/or the inverter board 30 arranged under the heating coil board 10.

This method of connecting boards with connectors eliminates complex wire connections, which increases assembly convenience, reduces the possibility of product defects, and reduces manufacturing costs.

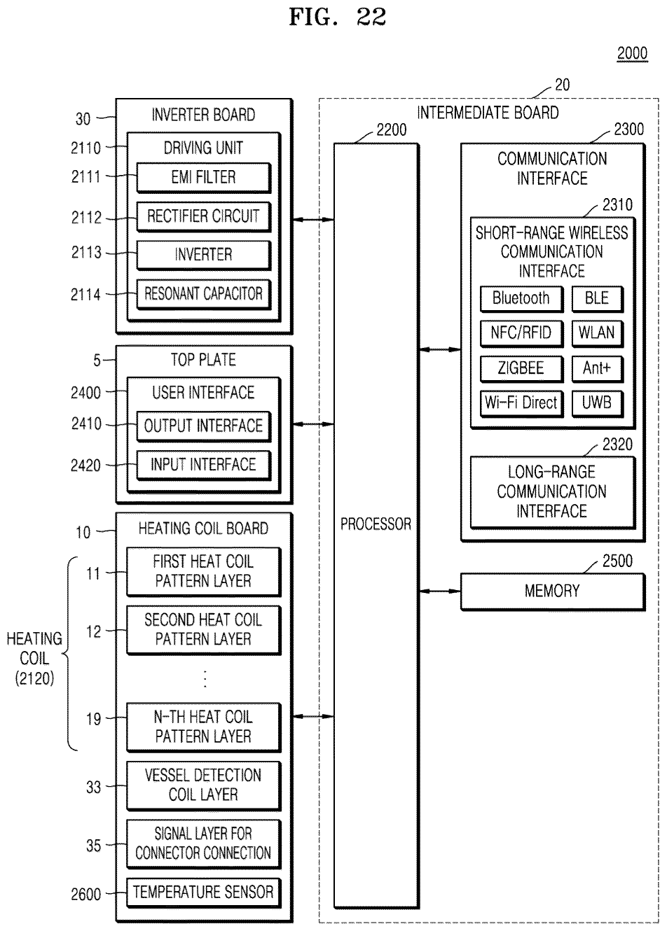

FIG. 22 is a block diagram of an induction heating device according to an embodiment of the disclosure.

As illustrated in FIG. 22, the induction heating device 2000 according to an embodiment of the disclosure may include the top plate 5, the heating coil board 10, the intermediate board 20, and the inverter board 30.

In the induction heating device 2000 according to an embodiment of the disclosure, the top plate 5 is a plate on which the cooking vessel 101 is to be placed, and is usually made of heat-resistant tempered glass. The top plate (5) may include an output interface 2410 such as a display, and an input interface 2420 such as a touch button. In an embodiment of the disclosure, the actual operation of the output interface 2410 such as a display and the input interface 2420 such as a touch button may be performed under control of a processor 2200 included in the intermediate board 20 to be described below. In addition, in an embodiment of the disclosure, a display panel or an actual touch button may be mounted on the intermediate board 20, and only the interfaces may be mounted on the top plate 5.

A user interface 2400 that may be included in the top plate 5 may include the output interface 2410 and the input interface 2420. The output interface 2410 is for outputting an audio signal or a video signal, and may include a display, an audio output unit, and the like.

In a case in which a display and a touch pad constitute a layer structure to form a touch screen, the display may serve as the input interface 2420 in addition to the output interface 2410. The display may include at least one of a liquid-crystal display, a thin-film-transistor liquid-crystal display, a light-emitting diode (LED) display, an organic LED display, a flexible display, a three-dimensional (3D) display, or an electrophoretic display. In addition, depending on the design, the induction heating device 2000 may include two or more displays.

The audio output unit may output audio data received from a communication interface 2300 or stored in a memory 2500. In addition, the audio output unit may output an audio signal related to a function performed by the induction heating device 2000. The audio output unit may include a speaker, a buzzer, and the like.

According to an embodiment of the disclosure, the output interface 2410 may display information about the cooking vessel 101. For example, the output interface 2410 may output a graphical user interface (GUI) corresponding to identification information or product type information of the cooking vessel 101. In addition, the output interface 2410 may output information about the current location of the cooking vessel 101 or the material of the cooking vessel 101.

The input interface 2420 is for receiving an input from a user. The input interface 2420 may be, but is not limited to, at least one of a key pad, a dome switch, a touch pad (e.g., a touch-type capacitive touch pad, a pressure-type resistive overlay touch pad, an infrared sensor-type touch pad, a surface acoustic wave conduction touch pad, an integration-type tension measurement touch pad, a piezoelectric effect-type touch pad), a jog wheel, or a jog switch.

The input interface 2420 may include a speech recognition module. For example, the induction heating device 2000 may receive, through a microphone, a voice signal, which is an analog signal, and convert a speech part into a computer-readable text by using an automatic speech recognition (ASR) model. The induction heating device 2000 may interpret the text by using a natural language understanding (NLU) model to obtain an utterance intention of the user. Here, the ASR model or the NLU model may be an artificial intelligence model. The artificial intelligence model may be processed by an artificial intelligence-dedicated processor designed in a hardware structure specialized for processing an artificial intelligence model. The artificial intelligence model may be generated via a training process. Here, being generated via a training process may mean that predefined operation rules or artificial intelligence model set to perform desired characteristics (or purposes), is generated by training a basic artificial intelligence model by using a learning algorithm that utilizes a large amount of training data. The artificial intelligence model may include a plurality of neural network layers. Each of the neural network layers has a plurality of weight values, and performs a neural network arithmetic operation via an arithmetic operation between an arithmetic operation result of a previous layer and the plurality of weight values.

Linguistic understanding is a technology for recognizing and applying/processing human language/characters, and includes natural language processing, machine translation, dialogue system, question answering, speech recognition/synthesis, and the like.

In the induction heating device 2000 according to an embodiment of the disclosure, the heating coil board 10 may include the heating coil 2120 printed for patterning on the first heating coil pattern layer 11. The heating coil board 10 may have a structure in which a plurality of heating coil pattern layers are stacked. A plurality of heating coils 2120 may be provided, and a plurality of heating coil pattern layers may include the first heating coil pattern layer 11, the second heating coil pattern layer 12, . . . , an n-th heating coil pattern layer 19 (n is a natural number greater than or equal to 2, and n may be 4, 8, 12, or 16). The heating coil board 10 may include the signal layer 35 for connector connection on which a connector may be vertically mounted, so as to be connected to the intermediate board 20 and/or the inverter board 30 through the connector without wires.

The heating coil 2120 applied to the heating coil board 10 for patterning may generate a magnetic field for heating the cooking vessel 101. For example, when a current is supplied to the heating coil 2120, a magnetic field may be induced around the heating coil 2120. When a current that changes in magnitude and direction over time, for example, an alternating current, is supplied to the heating coil 2120, a magnetic field that changes in magnitude and direction over time may be induced around the heating coil 2120. The magnetic field around the heating coil 2120 may pass through the top plate 5 made of tempered glass and reach the cooking vessel 101 placed on the top plate 5. An eddy current rotating around the magnetic field may be generated in the cooking vessel 101 due to the magnetic field that changes in magnitude and direction over time, and resistance heat may be generated in the cooking vessel 101 due to the eddy current. Resistance heat is heat generated in a resistor when a current flows therethrough, and is also referred to as Joule heat. The cooking vessel 101 is heated by the electrical resistance heat, and thus, the contents of the cooking vessel 101 may be heated.

In the induction heating device 2000 according to an embodiment of the disclosure, the heating coil board 10 may further include the temperature sensor 2600. The temperature sensor 2600 may sense the temperature of the top plate 5 or the cooking vessel 101 placed on the top plate 5. The processor 2200 may determine whether the cooking vessel 101 is being empty-heated or overheated, based on the temperature of the cooking vessel 101 sensed by the temperature sensor 2600. In an embodiment of the disclosure, the temperature sensor 2600 may be installed in a hole penetrating the heating coil board 10.

The heating coil board 10 of the induction heating device 2000 according to an embodiment of the disclosure may further include the vessel detection coil layer 33. In an embodiment of the disclosure, the vessel detection coil layer 33 may include a vessel detection coil. In an embodiment of the disclosure, the vessel detection coil may be printed as a pattern on the first heating coil pattern layer 11. The processor 2200 of the induction heating device 2000 may detect whether the cooking vessel 101 is placed on the top plate 5 of the induction heating device 2000, through the vessel detection coil included in the vessel detection coil layer 33 or the first heating coil pattern layer 11.

The inverter board 30 may include a driving unit 2110. The driving unit 2110 may receive power from an input power source and supply a current to the heating coil 2120 according to a driving control signal of the processor 2200. The driving unit 2110 may include, but is not limited to, the EMI filter 2111, the rectifier circuit 2112, the inverter 2113, and the resonant capacitor 2114. In an embodiment of the disclosure, depending on design specifications, the resonant capacitor 2114 may be located on the intermediate board 20 rather than the inverter board 30.

The EMI filter 2111 may filter out high-frequency noise included in an alternating-current voltage supplied from the input power source, and pass an alternating-current voltage and an alternating current with a predetermined frequency (e.g., 50 Hz or 60 Hz). A fuse and a relay for blocking an overcurrent may be provided between the EMI filter 2111 and the input power source. The alternating-current voltage from which high-frequency noise is filtered out by the EMI filter 2111 is supplied to the rectifier circuit 2112.

The rectifier circuit 2112 may convert the alternating-current voltage into a direct-current voltage. For example, the rectifier circuit 2112 may convert an alternating-current voltage that changes in magnitude and polarity (e.g., positive voltage or negative voltage) over time, into a direct-current voltage with a constant magnitude and polarity, and may convert an alternating current that changes in magnitude and direction (e.g., positive current or negative current) over time, into a direct current that does not change in polarity over time. The rectifier circuit 2112 may include a diode as an element for rectification. For example, the rectifier circuit 2112 may include four diodes. The diode may convert an alternating-current voltage that changes in polarity over time, into a positive voltage with a constant polarity, and may convert an alternating current that changes in direction over time, into a positive current with a constant direction. The rectifier circuit 2112 may be connected to a DC link capacitor that smooths the rectified direct-current voltage.

The inverter 2113 may include a switching circuit that supplies or blocks a driving current to the heating coil 2120. The inverter 2113 may cause resonance between the heating coil 2120 and the resonance capacitor 2114 through a switching operation of the switching circuit. In an embodiment of the disclosure, the resonant capacitor 2114 may be included in the inverter board 30, or may be included in the intermediate board 20. The switching circuit may include two switches for each heating zone as illustrated in FIG. 3. The first switch 2113_1 and the second switch 2113_2 illustrated in FIG. 3 may be turned on or off according to a driving control signal of the processor 2200. In an embodiment of the disclosure, the induction heating device 2000 may include, in addition to the processor 2200, a separate driving processor to generate a driving control signal.

The inverter 2113 may control a current supplied to the heating coil 2120. For example, the magnitude and direction of a current flowing in the first heating coil 2120_1 may change according to turning on or off of the first switch 2113_1 and the second switch 2113_2 included in the inverter 2113. In addition, the magnitude and direction of a current flowing in the second heating coil 2120_2 may change according to turning on or off of another pair of switches included in the inverter 2113. In this case, an alternating current may be supplied to the first heating coil 2120_1 and the second heating coil 2120_2.

The inverter board 30 may include a connector (not shown) for connection with the intermediate board 20.

In the induction heating device 2000 according to an embodiment of the disclosure, the intermediate board 20 may be arranged between the heating coil board 10 and the inverter board 30. When the inverter board 30 is a second board, the intermediate board 20 may be a first board. According to an embodiment of the disclosure, the intermediate board 20 may include, but is not limited to, the processor 2200, the communication interface 2300, and the memory 2500. For example, the intermediate board 20 may further include the resonant capacitor 2114. In addition, a component included in the intermediate board 20 may be electrically connected to a component included in the inverter board 30 through a connector of the inverter board 30.

According to an embodiment of the disclosure, the intermediate board 20 may include the resonant capacitor 2114. This is an embodiment, and the resonant capacitor 2114 may be included in the inverter board 30 depending on the design specifications. The resonant capacitor 2114 may induce an eddy current in the cooking vessel 101 placed on the top plate 5 of the induction heating device 2000 by resonating with the heating coil 2120 through switching of the inverter 2113. As illustrated in FIG. 3, in a case in which a plurality of heating coils 2120 are provided, a plurality of resonant capacitors 2114 may be provided to correspond to the heating coils 2120, respectively.

The processor 2200 of the intermediate board 20 may determine the switching frequency (e.g., a turn-on/turn-off frequency) of the switching circuit included in the inverter 2113 based on the output strength (power level) of the induction heating device 2000. The processor 2200 may generate a driving control signal for turning on or off the switching circuit according to the determined switching frequency. The induction heating device 2000 may include a separate driving processor from the processor 2200, for controlling the operation of the driving unit 2110 including the inverter 2113 during the operation of the processor 2200. However, this is only an embodiment and the operation of the driving processor may be performed by the processor 2200.

The processor 2200 controls the overall operation of the induction heating device 2000.

The processor 2200 is a hardware device that controls the overall operation of the induction heating device 2000. The processor 2200 may include one processor or a plurality of processors. The processor 2200 according to an embodiment of the disclosure may be a hardware processing circuit including at least one of a central processing unit (CPU), a graphics processing unit (GPU), an accelerated processing unit (APU), a many-integrated core (MIC), a digital signal processor (DSP), an integrated circuit, or a neural processing unit (NPU). The processor 2200 may be implemented in the form of an integrated system on a chip (SoC) including one or more electronic components. In a case in which the processor 2200 includes a plurality of processors, each processor may be implemented as separate hardware (H/W). The processor 2200 may be referred to as a microprocessor controller (MICOM), a microprocessor unit (MPU), or a microcontroller unit (MCU). The processor 2200 according to an embodiment of the disclosure is a hardware device that may be implemented as a single-core processor or a multi-core processor. The processor 2200 may execute programs stored in the memory 2500 to control the driving unit 2110, the communication interface 2300, the user interface 2400, and the memory 2500.

According to an embodiment of the disclosure, the induction heating device 2000 may be equipped with an artificial intelligence (AI) processor. The AI processor may be manufactured in the form of a dedicated hardware chip for AI, or may be manufactured as part of an existing general-purpose processor (e.g., a CPU or an application processor) or a dedicated graphics processor (e.g., a GPU), and then mounted on the induction heating device 2000.

In a case in which unique identification information of the cooking vessel 101 is stored in the memory 2500, the processor 2200 may establish a short-range wireless communication channel (e.g., a BLE communication channel) with the cooking vessel 101 through the communication interface 2300.

The processor 2200 may perform asymmetric control between the plurality of heating coils 2120. In an embodiment of the disclosure, when the operating frequency of the first heating coil 2120_1 of FIG. 3 is f₁ and the operating frequency of the second heating coil 2120_2 is f₂ (f₁<f₂), the processor 2200 may control the operating frequency of the second heating coil 2120_2 such that f₂=f₁. At the same time, the processor 2200 may perform asymmetric control to set the turn-on/turn-off duties of the third switch 2113_3 and the fourth switch 2113_4 differently when the operating frequency is f₁ such that the output of the heating zone corresponding to the second heating coil 2120_2 when the operating frequency of the second heating coil 2120_2 is f₂ is the same as the output when the operating frequency of the second heating coil 2120_2 is f₁.

The communication interface 2300 of the intermediate board 20 may include one or more components that enable communication between the induction heating device 2000 and the cooking vessel 101, between the induction heating device 2000 and a server (not shown), or between the induction heating device 2000 and a user terminal (not shown). For example, the communication interface 2300 may include a short-range wireless communication interface 2310 and a long-range communication interface 2320. The short-range wireless communication interface 2310 may include, but is not limited to, a Bluetooth communication unit, a BLE mesh network communication unit, an NFC unit, a WLAN (e.g., Wi-Fi) communication unit, a Zigbee communication unit, an IrDA communication unit, a WFD communication unit, a UWB communication unit, an Ant+ communication unit, and the like. In a case in which the cooking vessel 101 is remotely controlled by a server (not shown) in an internet-of-Things (IoT) environment, the long-range communication interface 2320 may be used to communicate with the server. The long-range communication interface 2320 may include the Internet, a computer network (e.g., a LAN or a WAN), and a mobile communication unit. The mobile communication unit transmits and receives radio signals to and from at least one of a base station, an external terminal, or a server, on a mobile communication network. Here, the radio signals may include a voice call signal, a video call signal, or various types of data according to text/multimedia message transmission and reception. The mobile communication unit may include, but is not limited to, a 3G module, a 4G module, an LTE module, a 5G module, a 6^{th} Generation (6G) module, an NB-IoT module, an LTE-M module, and the like.

The memory 2500 may store a program for the processor 2200 to perform the operation and control of the induction heating device 2000, and may store input/output data (e.g., unique identification information of the cooking vessel 101, variable identification information of the cooking vessel 101, a plurality of power transmission patterns, cooking progress information of the cooking vessel 101, or material information of the cooking vessel 101). The memory 2500 may store a coded command regarding a switching operation for driving the inverter 2113. In addition, the memory 2500 may also store an AI model.

The memory 2500 may include at least one of a flash memory-type storage medium, a hard disk-type storage medium, a multimedia card micro-type storage medium, a card-type memory (e.g., SD or XD memory), random-access memory (RAM), static RAM (SRAM), read-only memory (ROM), electrically erasable programmable ROM (EEPROM), programmable ROM (PROM), magnetic memory, a magnetic disk, or an optical disc. In addition, the induction heating device 2000 may operate a web storage or a cloud server that performs a storage function on the Internet.

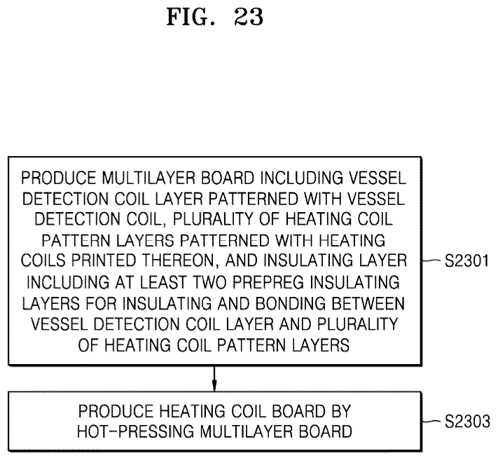

FIG. 23 is a flowchart of producing a heating coil board, according to an embodiment of the disclosure.

In operation S2301, a multilayer board is produced including a vessel detection coil layer patterned with a vessel detection coil, a plurality of heating coil pattern layers patterned with heating coils printed thereon, and an insulating layer for insulating and bonding between the vessel detection coil layer and the plurality of heating coil pattern layers. The insulating layer may be produced by stacking at least two prepreg insulating layers. The thickness of the insulating layer when hot-pressed may be 130 μm or less, or 140 μm or less. In addition, the thickness of the vessel detection coil layer when hot-pressed may be 110 μm or less.

The vessel detection coil layer may be arranged in the uppermost layer of the multilayer board, and an insulating layer may be inserted between the vessel detection coil layer and the uppermost layer of the plurality of heating coil pattern layers. The insulating layer may include two prepreg insulating layers. In addition, at least two prepreg insulating layers may be inserted between the plurality of heating coil pattern layers. The thickness of the prepreg insulating layer before hot-pressing may be 65 μm or less. In addition, the lowermost layer of the multilayer board may include a signal layer for connector connection. An insulating layer may be inserted between the signal layer for connector connection and the lowermost layer of the plurality of heating coil pattern layers. The insulating layer may be produced by stacking at least two prepreg insulating layers. The thickness of the insulating layer when hot-pressed may be 130 μm or less, or 140 μm or less. In addition, the thickness of the signal layer for connector connection when hot-pressed may be 110 μm or less.

Here, a PCB substrate for producing the multilayer board may have a size of 1020 (mm)×1200 (mm) or 1020 (mm)×1020 (mm), and 2 ounces or more of copper are used in a PCB substrate to be used for producing the heating coil board. 0.5 ounces to 1 ounce of copper may be used in a PCB substrate used for the vessel detection coil layer and the signal layer for connector connection.

Each prepreg insulating layer includes a resin content of 60% to 80%.

Each layer of the multilayer board may include a hole through which a temperature sensor for detecting the temperature of a cooking vessel may pass.

In operation S2303, a heating coil board is produced by hot-pressing the multilayer board. Because two prepreg insulating layers are provided, conductors of the plurality of heating coil pattern layers and reinforced fibers of the prepreg insulating layers do not come into contact with each other even when the multilayer board is hot-pressed, and thus, insulation is maintained. The thickness of the heating coil board produced through hot-pressing may be 3.3 mm or less.

According to an embodiment of the disclosure, disclosed is an induction heating device including a vessel detection coil layer patterned with a plurality of vessel detection coils printed thereon for detecting a cooking vessel. According to an embodiment of the disclosure, the induction heating device may include a plurality of heating coil pattern layers that are patterned with heating coils printed thereon, and an insulating layer arranged between the plurality of heating coil pattern layers and the vessel detection coil layer, to insulate the plurality of heating coil pattern layers from the vessel detection coil layer. According to an embodiment of the disclosure, the vessel detection coil layer, the plurality of heating coil pattern layers, and the insulating layer may be stacked and hot- pressed to form a heating coil board. According to an embodiment of the disclosure, a thickness of the insulating layer after the hot-pressing may be 140 μm or less.

According to an embodiment of the disclosure, the insulating layer may include a resin content of 60% to 80% of a total composition.

According to an embodiment of the disclosure, heights of conductors of the plurality of heating coil pattern layers may be 60 μm or greater. According to an embodiment of the disclosure, in the heating coil board formed by stacking and hot-pressing the vessel detection coil layer, the plurality of heating coil pattern layers, and the insulating layer, the conductor of an uppermost layer of the plurality of heating coil pattern layers or a conductor of the vessel detection coil may not come into contact with a reinforced fiber of the insulating layer such that insulation is maintained.

According to an embodiment of the disclosure, the heating coil board may include a hole that allows a temperature sensor configured to detect a temperature of a cooking vessel to pass therethrough.

According to an embodiment of the disclosure, the insulating layer may be formed by stacking at least two prepreg insulating layers.

According to an embodiment of the disclosure, a first end of each of the plurality of vessel detection coils may be connected to a lowermost layer of the heating coil board through a via hole. According to an embodiment of the disclosure, a second end of each of the plurality of vessel detection coils may be connected to a connector terminal arranged on the vessel detection coil layer.

According to an embodiment of the disclosure, the induction heating device may further include at least one processor. According to an embodiment of the disclosure, the induction heating device my include the at least one processor including processing circuitry and a memory storing instructions that, when executed by the at least one further processor individually and collectively, cause the induction heating device to detect, through the plurality of vessel detection coils, at least one of a material of a cooking vessel placed on a top plate of the induction heating device, a position of the cooking vessel, or a presence or absence of the cooking vessel.

According to an embodiment of the disclosure, the at least one processor may be further configured to detect the material of the cooking vessel through a change in inductance due to the cooking vessel detected by the vessel detection coil.

According to an embodiment of the disclosure, the induction heating device may further include a display. According to an embodiment of the disclosure, the induction heating device is caused to control the display to display a grade of the cooking vessel according to the detected material of the cooking vessel.

According to an embodiment of the disclosure, the plurality of heating coil pattern layers may be eight or more layers.

According to an embodiment of the disclosure, a thickness of the heating coil board may be 3.3 mm or less.

According to an embodiment of the disclosure, the vessel detection coil layer may further include a temperature sensor configured to measure a temperature of the heating coil board.

According to an embodiment of the disclosure, the instructions stored in a memory, when executed by at least one processor included in the induction heating device individually or collectively, cause the induction heating device to reduce heating output through the heating coil board based on the temperature of the heating coil board measured by the temperature sensor being greater than or equal to a preset overheating reference temperature.

According to an embodiment of the disclosure, the temperature sensor may include a PTC thermistor or an NTC thermistor.

According to an embodiment of the disclosure, the induction heating device may further include an inverter board connected to the heating coil board through a connector. According to an embodiment of the disclosure, the heating coil board may further include, in the lowermost layer thereof, a signal layer for connector connection to be connected to the inverter board through a connector.

According to an embodiment of the disclosure, the first end of each of the plurality of vessel detection coils may be connected to the signal layer for connector connection through a via hole, to be connected to a heating board connector that is vertically connected to the signal layer for connector connection. According to an embodiment of the disclosure, the second end of each of the plurality of vessel detection coils may be connected to a terminal of a heating board connector on the vessel detection coil layer.

According to an embodiment of the disclosure, the inverter board may include at least one inverter board connector that is connected to the heating board connector and mounted vertically on the inverter board.

According to an embodiment of the disclosure, the induction heating device may further include an intermediate board that is arranged between the heating coil board and the inverter board, and includes a memory storing a program for controlling an operation of the induction heating device, and at least one processor configured to execute the program stored in the memory to control the induction heating device. According to an embodiment of the disclosure, the intermediate board may further include a hole through which the heating board connector passes.

According to an embodiment of the disclosure, at least two prepreg insulating layers may be arranged between the plurality of heating coil pattern layers to insulate and bond the plurality of heating coil pattern layers.

According to an embodiment of the disclosure, disclosed is a method of producing a heating coil board including a vessel detection coil layer patterned with a vessel detection coil, in an induction heating device. According to an embodiment of the disclosure, the method may include forming a multilayer board including a plurality of heating coil pattern layers that are pattered with heating coils printed thereon, and an insulating layer arranged between the plurality of heating coil pattern layers and the vessel detection coil layer to insulate and bond between the plurality of heating coil pattern layers and the vessel detection coil layer. According to an embodiment of the disclosure, the method of producing a heating coil board including a vessel detection coil layer patterned with a vessel detection coil in an induction heating device may include forming a heating coil board by hot-pressing the multilayer board. According to an embodiment of the disclosure, a thickness of the insulating layer after the hot-pressing may be 140 μm or less.

A method according to an embodiment of the disclosure may be embodied as program commands executable by various computer devices, and recorded on a computer-readable medium. The computer-readable medium may include program commands, data files, data structures, or the like separately or in combinations. The program commands to be recorded on the medium may be specially designed and configured for the disclosure or may be well-known to and be usable by those skill in the art of computer software. Examples of the computer-readable recording medium include magnetic media such as hard disks, floppy disks, or magnetic tapes, optical media such as a compact disc ROM (CD-ROM) or a digital video disc (DVD), magneto-optical media such as a floptical disk, and hardware devices such as ROM, RAM, or flash memory, which are specially configured to store and execute program commands. Examples of program commands include not only machine code, such as code made by a compiler, but also high-level language code that is executable by a computer by using an interpreter or the like.

An embodiment of the disclosure may be implemented as a recording medium including computer-readable instructions such as a computer-executable program module. The computer-readable medium may be any available medium which is accessible by a computer, and may include a volatile or non-volatile medium and a removable or non-removable medium. Also, the computer-readable medium may include a computer storage medium and a communication medium. The computer storage media include both volatile and non-volatile, removable and non-removable media implemented in any method or technique for storing information such as computer-readable instructions, data structures, program modules or other data. The communication media typically include computer-readable instructions, data structures, program modules, other data of a modulated data signal, or other transmission mechanisms, and examples thereof include an arbitrary information transmission medium. Also, an embodiment of the disclosure may be implemented as a computer program or a computer program product including computer-executable instructions such as a computer program executed by a computer.

A machine-readable storage medium may be provided in the form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the ‘non-transitory storage medium’ may include a buffer in which data is temporarily stored.

According to an embodiment of the disclosure, methods according to an embodiment disclosed herein may be included in a computer program product and then provided. The computer program product may be traded as commodities between sellers and buyers. The computer program product may be distributed in the form of a machine-readable storage medium (e.g., a CD-ROM), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer's server, an application store's server, or a memory of a relay server.

1. An induction heating device comprising:
a vessel detection coil layer that is patterned with a plurality of vessel detection coils printed thereon to detect a cooking vessel placed on the induction heating device;
a plurality of heating coil pattern layers that are patterned with heating coils printed thereon; and
an insulating layer between the plurality of heating coil pattern layers and the vessel detection coil layer, to insulate the plurality of heating coil pattern layers from the vessel detection coil layer,
wherein the vessel detection coil layer, the plurality of heating coil pattern layers, and the insulating layer are in a stacked, hot-pressed heating coil board in which a thickness of the insulating layer is 140 μm or less.

2. The induction heating device of claim 1, wherein
the insulating layer includes a resin content of 60% to 80% of a total composition.

3. The induction heating device of claim 1, wherein
the insulating layer includes a reinforced fiber,
the plurality of heating coil pattern layers include conductors with heights of 60 μm or greater, and
the reinforced fiber of the insulating layer does not contact a conductor of an uppermost heating coil pattern layer of the plurality of heating coil pattern layers or a conductor of the vessel detection coil layer.

4. The induction heating device of claim 1, wherein
the stacked, hot-pressed heating coil board includes a hole through which a temperature sensor configured to detect a temperature of a cooking vessel is passable.

5. The induction heating device of claim 3, wherein
the insulating layer includes at least two prepreg insulating layers.

6. The induction heating device of claim 1, further comprising:
a connector terminal on the vessel detection coil layer,
wherein a first end of each vessel detection coil of the plurality of vessel detection coils is connected to a lowermost layer of the stacked, hot-pressed heating coil board through a via hole, and
a second end of each vessel detection coil of the plurality of vessel detection coils is connected to the connector terminal on the vessel detection coil layer.

7. The induction heating device of claim 1, further comprising:
a top plate on which to place a cooking vessel,
at least one processor comprising processing circuitry, and
a memory storing instructions that, when executed by the at least one processor individually or collectively, cause the induction heating device to detect, through the plurality of vessel detection coils, at least one of a material of a cooking vessel placed on the top plate, a position of the cooking vessel on the top plate, or a presence or absence of the cooking vessel.

8. The induction heating device of claim 7, wherein
the instructions, when executed by the at least one processor, cause the induction heating device to detect the material of the cooking vessel through a change in inductance due to the cooking vessel detected by the plurality of vessel detection coils.

9. The induction heating device of claim 7, further comprising:
a display,
wherein the instructions, when executed by the at least one processor, cause the display to display a grade of the cooking vessel according to the detected material of the cooking vessel.

10. The induction heating device of claim 1, wherein
the plurality of heating coil pattern layers includes eight or more heating coil pattern layers.

11. The induction heating device of claim 1, wherein
a thickness of the stacked, hot-pressed heating coil board is 3.3 mm or less.

12. The induction heating device of claim 1, wherein
the vessel detection coil layer includes a temperature sensor configured to measure a temperature of the stacked, hot-pressed heating coil board.

13. The induction heating device of claim 12, further comprising:
at least one processor comprising processing circuitry, and
a memory storing instructions that, when executed by the at least one processor individually or collectively, cause the induction heating device to, based on the measured temperature of the stacked, hot-pressed heating coil board being greater than a preset overheating reference temperature, reduce heating output through the stacked, hot-pressed heating coil board.

14. The induction heating device of claim 12, wherein
the temperature sensor includes a positive temperature coefficient (PTC) thermistor or a negative temperature coefficient (NTC) thermistor.

15. The induction heating device of claim 1, further comprising:
an inverter board connected to the stacked, hot-pressed heating coil board through a connector,
wherein the stacked, hot-pressed heating coil board includes, in a lowermost layer, a signal layer connected to the inverter board through the connector.

16. The induction heating device of claim 15, wherein
a first end of each vessel detection coil of the plurality of vessel detection coils is connected to the signal layer through a via hole, to be connected to a heating board connector that is vertically connected to the signal layer, and
a second end of each vessel detection coil of the plurality of vessel detection coils is connected to a terminal of a heating board connector on the vessel detection coil layer.

17. The induction heating device of claim 16, wherein
the inverter board includes at least one inverter board connector that is connected to the heating board connector and mounted vertically on the inverter board.

18. The induction heating device of claim 17, further comprising:
an intermediate board between the stacked, hot-pressed heating coil board and the inverter board which comprises
at least one processor comprising processing circuitry, and
a memory storing instructions, when executed by the at least one processor individually or collectively, cause to
control the induction heating device,
wherein the intermediate board includes a hole through which the heating board connector passes.

19. The induction heating device of claim 1, wherein
at least two prepreg insulating layers are arranged between each sequential heating coil pattern layer among the plurality of heating coil pattern layers to insulate and bond the plurality of heating coil pattern layers.

20. A method of producing a heating coil board for an induction heating device including a vessel detection coil layer, the method comprising:
forming a multilayer board including:
a vessel detection coil layer that is patterned with a vessel detection coil printed thereon,
a plurality of heating coil pattern layers that are pattered with heating coils printed thereon, and
an insulating layer between the plurality of heating coil pattern layers and the vessel detection coil layer to insulate and bond between the plurality of heating coil pattern layers and the vessel detection coil layer; and
forming a heating coil board by hot-pressing the multilayer board,
wherein a thickness of the insulating layer after the hot-pressing of the multilayer board is 140 μm or less.
